(19) United States
(12) Patent Application Publication
(10) Pub. No.: US 2020/0334514 A1
(43) Pub. Date: Oct. 22, 2020

(54) Hand-Tearing Texture Anti-fake Method and Product and Material Thereof

(71) Applicant: PPK (HAINAN) AI CO. LTD [CN/CN], Haikou (CN)

(72) Inventor: Mingfa CHEN, Haikou (CN)

(73) Assignee: PPK (HAINAN) AI CO. LTD [CN/CN]

(21) Appl. No.: 16/916,184

(22) Filed: Jun. 30, 2020

Related U.S. Application Data
(63) Continuation of application No. PCT/CN2018/113408, filed on Nov. 1, 2018.

(30) Foreign Application Priority Data
Jan. 2, 2018 (CN) 201810001868.1
Jan. 6, 2018 (CN) 201810013273.8
Sep. 21, 2018 (CN) 201821549321.7
Oct. 15, 2018 (CN) 201811194516.9

(51) Int. Cl. G06K 19/08; B41M 3/14; G07D 7/20; B41J 3/407; G06K 19/06; G06F 16/901

(52) U.S. Cl. CPC G06K 19/086; B41M 3/14; G06F 16/901; B41J 3/407; G06K 19/06037; G07D 7/20

(57) ABSTRACT

The present invention provides a hand-tearing texture anti-fake method and a product and a material thereof Fancy yarn is embedded in a printed matter and a printing material, and the fancy yarn and personalized elements thereof are flattened and shaped into a flat texture string; and the personalized feature information of the flat texture string is collected and stored in an anti-fake check system database as a texture information file. The present invention overcomes the disadvantages of needle-picking fibers (texture) and achieves the purpose of checking the texture by hand, facilitates the public to discriminate true textures from false ones by hand, avoids the trouble of anti-fake application of needle-picking texture, simplifies the production of texture paper, and avoids the contamination of the workshop environment of ordinary white paper by residual fibers.

### TECHNICAL FIELD

The present invention belongs to the anti-fake technical field of information query, and particularly, relates to an improved application of Chinese patents “Structural Texture Anti-fake Method (CN1074563C)” and “Structural Texture Anti-fake Marker (CN2365711Y)”.

### BACKGROUND

The “Structural Texture Anti-fake Method (CN1074563C)” invented by the inventor (Mr. Chen Mingfa) of the present application obtains international patent (PCT/CN99/00102) such as Chinese patent, US patent (with the certificate number of U.S. Pat. No. 6,623,041), Russian patent (with the certificate number of 2202127), Korean patent (with the certificate number of 0419436) and Vietnamese patent (with the certificate number of 3347). The “Structural Texture Anti-fake Marker (CN2365711Y)” obtains Chinese utility model patent. A printing material (2) with a random structural texture (1) (for example, a texture formed by black chemical fibers with a length of 2-3 mm and a thickness of 0.1 mm added in white paper) is selected to produce a printed matter (3); each printed matter (3) is printed with a unique code (4); and the feature information of the random structural texture (1) on the printed matter (3) is photographed and collected as a texture information file (i.e., the basis for identifying authenticity), and stored in correspondence to the code (i.e., index code) in an anti-fake check system database (of a computer connected to the telephone network or Internet) for the public to check whether the random structural texture (1) on the printed matter (3) is consistent with the texture information file recorded in the database by means of communication such as telephone, short message service, multimedia messaging service, WeChat, 4G, WAP and computer with Internet access so as to check the authenticity. The patent “grafts the ancient anti-fake principle for tiger tally with the modem communication technology and computer technology”, creates a new anti-fake field and is awarded by the national review and appraisal conference organized by the “National Anti-counterfeiting Office and China Trade Association for Anti-counterfeiting the world's first, international advanced and long-term effective anti-fake technical product which is extremely difficult to counterfeit and easy to identify. After nearly 20 years' promotion, the patent has now become the mainstream anti-fake technical product in the domestic anti-fake market.

In the “Structural Texture Anti-fake Method (CN1074563C)” of the above background, the random structural texture (1) in the printing material (2) used by the printed matter (3) is a full-page random structural texture (1) formed by personalized elements such as fibers, chips, irregularly shaped particles, bubbles and sundries randomly distributed and mixed in the printing material (2) such as paper. For a long time, such an application problem always exists: in order to identify the false texture that is copied and counterfeited, users need to constantly publicize and warn the public that the (short and thin) fibers in the paper are not printed ink and can be picked out with a needle. Please make an inspection by needle picking (For details, see 2018 “Mobil New Packaging Authenticity Identification Guide Video” by Baidu search). The contradiction between ideals and reality is that: if fibers are too long, it is impossible to make paper, and if fibers are too short, the inspection by needle picking is required and it is impossible to inspect by tearing by hand.

Since 99.9% of consumers have no sharp tools such as needle on hand when shopping, fake commodities that use false texture anti-fake printed matters, which are copied and counterfeited are bought back mistakenly by consumers because the inspection by needle picking cannot be conducted. In other words, consumers are required to check the authenticity of a texture by needle picking, and the step of discriminating true textures from false ones is very inconvenient, so the anti-fake effect of the current “structural texture anti-fake method” is greatly reduced.

For a long time, the disadvantages of discriminating true textures from false ones by needle picking greatly reduce the anti-fake effect of the “structural texture anti-fake method”. How to enable the public to discriminate true textures from false ones by hand is an application problem that has puzzled the texture anti-fake industry for more than ten years.

In addition, the texture (fiber) paper required for implementing the current “Structural Texture Anti-fake Method (CN1074563C)” is special paper. In order to meet the needs of sensory identification such as “visible to the naked eyes and capable of being picked out with a needle”, the fiber standard is set to dark chemical short fibers with a length of 1.2-2.6 mm and a thickness of 60-70 μm (a width easy to discriminate by human eyes). Longer fibers may agglomerate during mixing and cannot be mixed with pulp, so the current papermaking process cannot make longer fiber texture paper. To make texture paper from the fibers, a three-layer rotary screen paper machine is required. The fibers are mixed in the middle-layer pulp according to the proportion of 3-7% to produce full-page texture paper (see FIG. 23) containing randomly distributed fibers in the middle layer, wherein the underlying and surface pulp protects the fibers in the middle-layer pulp, which can prevent the fibers from accidentally falling off. The texture paper production process has a serious disadvantage that: the fibers will pass through the pulp chest, the pulp pipeline, the paper machine and the waste pulp recycle pool along with the pulp, and the fibers remaining in the pulp chest, the pulp pipeline, the paper machine, the waste pulp recycle pool and other places must be thoroughly cleaned after a batch of texture paper, is produced; otherwise, the residual fibers will inevitably mix in another batch of newly produced ordinary white paper, causing ordinary white paper to be contaminated and thus scrapped. A domestic paper mill supplying texture paper to the applicant once joked that the characteristic of making texture paper is “spending two days in making paper and three days in cleaning, which causes more harm than good”. The paper mill also has three quality accidents that residual fibers contaminate ordinary white paper, which has resulted in residual fibers occurring in certain cigarette paper in China, leading to the return of more than 180 tons of cigarette paper from the cigarette factory to the paper mill and thus causing the economic loss of more than 2 million yuan to the paper mill.

To avoid the economic loss of the paper mill and overcome the difficult problem that the papermaking technology fibers contaminate workshops and production devices, one of the inventors (Chen Fei) of the present application also researches, and applies for a “Local Texture Anti-fake Printed Matter (Chinese invention patent licensing announcement No.: CN101556750B)”, and the applicant also invests tens of millions of yuan and spends more than ten years in researching and applying for more than ten process technology and production device patents about local (non-full-page/non-papermaking) texture.

Baidu Baike: Yarn is a kind of textile and a product formed by processing various textile fibers and having certain fineness, and is used for weaving, rope making, thread making, knitting, embroidery and the like and divided into short fiber yarn and continuous filament. Yarn is divided into: \textcircled{1} short fiber yarn, formed by spinning short fibers (natural short fibers or fibers cut from chemical fibers) and classified into ring spun yarn, open-end spinning yarn and self-twisting yarn: \textcircled{2} continuous filament, such as natural silk and chemical filament, classified into twisting or non-twisting smooth filament or textured filament; \textcircled{3} combination yarn of short fibers and continuous filament, such as polyester filament core spun yarn.

Single yarn means yarn formed by twisting one fiber bundle. One raw material can be spun into pure spinning yarn, thereby forming pure yarn fabric, or two or more raw materials constitute blended yarn, thereby forming blended fabric. A single filament is formed by one fiber filament, and the diameter of the single filament depends on the thickness of the fiber filament.

Folded yarn is yarn formed by twisting two or more strands of single yarn, and has higher strength and abrasive resistance than single yarn. Meanwhile, the folded yarn also can be plied and twisted in a certain way, thereby obtaining second-twist folded yarn such as two folded yarn, three folded yarn and multi-folded yarn, mainly used as sewing thread, braided thread, or strong fabric with medium thickness.

The textured yarn is obtained by deforming the synthetic fiber filament from straight to curved, also called textured filament or processed filament. The textured yarn includes high stretch yarn, low stretch yarn, interlaced yarn and the like.

Fancy yarn means yarn obtained by processing fibers or yarn with special raw materials, special equipment or special process in the process of spinning and thread making and having special structure and appearance effect, and is a kind of yarn with decorative effect among yarn products. Fancy yarn can be roughly divided into the following categories according to the processing methods: the first is fancy yarn processed by an ordinary spinning system, such as chain yarn, metallic yarn and wired yarn; the second is fancy yarn processed by a staining method, such as heather yarn, chine yarn and rainbow yarn; the third is fancy yarn processed by a fancy twister, which can be further divided into overfeed type such as spiral yarn, pigtail yarn and loop yarn, and controlled type such as big-belly yarn and knot yarn according to the difference and variation of feeding speeds of core yarn and decorative yarn; and the fourth is special fancy yarn such as chenille yarn, core-spun yarn, brushed yarn and flocked yarn.

### SUMMARY

The first purpose of the present invention is to provide a hand-tearing texture anti-fake (product manufacturing and identification) method, so as to facilitate the public to discriminate true textures from false ones by hand, improve the anti-fake effect of a “structural texture anti-fake method”, and overcome the application problems of texture anti-fake.

The second purpose, of the present invention is to provide a hand-tearing texture anti-fake product, so as to facilitate the public to discriminate true textures from false ones by hand, improve the anti-fake effect of a “structural texture anti-fake printed matter”, and overcome the application problems of texture anti-fake.

The third purpose of the present invention is to provide a hand tearing texture anti-fake material, so as to simplify the production of texture paper and avoid the contamination of ordinary white paper by residual fibers.

The hand-tearing texture anti-fake (product manufacturing and identification) method of the present invention has the following technical solution.

A hand-tearing texture anti-fake (product manufacturing and identification) method, comprising that at least one unique code (4) for each printed matter (3) is compiled and printed, and the feature information of a random structural texture (1) on each printed matter (3) is collected and stored in correspondence to the code (4) in an anti-fake check system database (of a computer connected to the Internet) as a texture information file of the printed matter (3) for the public to check the authenticity; and characterized by comprising the following steps \textcircled{1}-\textcircled{4}:

\textcircled{1} Embedding fancy yarn (5) under a transparent (including translucent) surface layer (8) on the printed matter (3); flattening (i.e., widening and thinning) and shaping (i.e., fixing to maintain the shape stability of) the fancy yarn (5) and personalized elements (10) thereon (which can be bent and deformed arbitrarily in three-dimensional space, are fluffy, and are erratic in form) and thereby forming a line string of the random structural texture (1) with a flat and stable shape—called a flat texture string (9) for short; and making the thickness of the area where the flat texture string (9) is located on the printed matter (3) greater than the surrounding area by 0-80 μm, 20-75 μm, 30-73 μm, 40-70 μm or 50-68 μm. It is preferred to make the flat texture string (9) stand for a period of time (for example, 0.25-24 hours) until stress is released, the string is naturally rebound and the shape is completely stable (i.e. completely shaped) before photographing and collecting the feature information of the flat texture string (9) on the printed matter (3), and then store the collected feature information of the flat texture string (9) in the database as the anti-fake feature information of the printed matter (3).

Here, the purpose of flattening the fancy yarn (5) and the personalized elements (10) thereof is to transform them into a random structural texture (1) which is owned by each printed matter (3), stable (unchangeable for life) in form, firmly bonded to a printing material, and more personalized in shape, and is also to keep the printed matter (3) flat for stacking and automatic labeling. It is well known that fancy yarn (5) is characterized in softness and fluffiness, has no fixed form, and can be bent arbitrarily for use on textile; and the form of the personalized elements (10) thereon, such as fluff, thread residues, branches, loops, knots and specks, is erratic in three-dimensional space. Here, the fancy yarn and the personalized elements thereon are rolled and stretched to become visually wide (up to a width recognizable by human eyes) but not thick; become stable (unchangeable for life) in form; be firmly bonded to a printing material; become more personalized in shape; and thereby being able to adapt to the identification needs of the current texture anti-fake technology.

According to the national standard for texture anti-fake technology of being recognizable by naked eye, fibers forming the personalized elements need to be thicker fibers of 60-70 μm. Studies show that, contrary to the needs, during papermaking, if unflattened thick (up to a width recognizable by human eyes) fancy yarn (5) and thick personalized elements (10) thereon are directly put in pulp and embedded in paper, the paper produced will have the situation that the fancy yarn (5) and the personalized elements (10) thereon absorb a lot of pulp fibers and become thicker, and thereby making the area where the fancy yarn and the personalized elements are located seriously raised (thickened by more than 85 μm). This will cause machine stop repeatedly due to the paper being unable to wind up normally, and as the local area of the paper is seriously thickened, the paper cannot be used for printing.

Studies also show that, contrary to the needs, during composition, if unflattened thick (up to a width recognizable by human eyes) fancy yarn (5) and thick personalized elements (10) thereon are directly immersed in glue and then pulled up and embedded in a sandwich layer, the composite material produced will have the situation that the fancy yarn (5) and the personalized elements (10) thereon absorb a lot of glue and become thicker, and thereby making the area where the fancy yarn and the personalized elements are located seriously raised (thickened by more than 85 μm). This will cause machine stop repeatedly due to the composite material being unable to wind up normally, and as the local area of the composite material is seriously thickened, the composite material cannot be used for printing.

Here, the purpose of shaping the fancy yarn (5) and the personalized elements (10) thereof is to transform them into a random structural texture (1) which is owned by each printed matter (3) and stable (unchangeable for life) in form. It is well known that fancy yarn (5) is characterized in softness and fluffiness, has no fixed form, and can be bent arbitrarily for use on textile; and the form of the personalized elements (10) thereon, such as fluff, thread residues, branches, loops, knots and specks, is erratic in three-dimensional space. Only after a feature is shaped and transformed into a stable personalized feature can it be used as a personalized anti-fake feature of the printed matter (3), used for identification, and used as an anti-fake feature.

Studies further show that, during post-processing as well as commodity circulation and storage process, unflattened and unshaped paper and composite material will naturally deform due to temperature, humidity, extrusion and other environmental factors with the lapse of time, which may easily lead to the problem that the personalized elements (10) seen by consumers (the public) and recognition software are not very consistent with an anti-fake feature information file thereof, and thereby easily leading to the situation that it is difficult to distinguish between true and false textures.

\textcircled{2} After the stress of the flat texture string (9) is relieved, the string is naturally rebound and the shape is completely stable, collecting the (shape, color and other personalized) feature information of the flat texture string (9) in each printed matter (3), and then storing the collected feature information in an anti-fake check system database (of a computer connected to the Internet) as a texture information file.

\textcircled{3} The public uses smart phones to check by an anti-fake check system whether the features of the flat texture string (9) in the printed matter (3) are consistent with the texture information file thereof.

\textcircled{4} Making a public announcement (or reminder) that
If the features of the flat texture string (9) are inconsistent with the texture information file thereof, the printed matter (3) checked is false;
If [the features of the flat texture string (9) are consistent with the texture information file thereof and] the flat texture string (9) is a real object that can be torn out and/or toggled (instead of a printed ink mark), the printed matter (3) checked is true; otherwise, the printed matter (3) checked is false;

\textcircled{5} The public tear the flat texture string (9) by hand and destructively check the existence of the real object of the flat texture string (9), in the printed matter (3); the public touch the area where the flat texture string (9) is located on the printed matter (3) by hand to perceive whether the real object of the flat texture string (9) is raised and exists; or the public toggle an exposed line segment (20) by fingers to perceive whether the exposed line segment is a real object. It should be noted here that as the fibers and other textures distributed randomly in the anti-fake carrier of the background art are short and dispersed fibers, the fibers are found to be difficult for the public to check by hand in application and practice, in other words, the tactile sensation of the fibers is not obvious and the fibers are difficult to identify. Whereas the flat texture string (9) in the present invention has a very obvious tactile sensation and is easy to identify.

The flat texture string (9) of the present invention has a plurality of curves with random shapes (such as bent, spiral and curly curves), a plurality of nodes/specks with random positions, a plurality of branches with random shapes, or a plurality of knots with random shapes, a plurality of burrs with random distribution, a plurality of fluff, a plurality of thread residues with random distribution, a plurality of line loops with random distribution, a plurality of twisted/deformed edge threads, or a combination of the above features. The above-mentioned various random features are the personalized elements (10) that compose the flat texture string (9). It is the random distribution and random shaping of the personalized elements (10) that form the flat texture string (9) with obvious personalized features.

Preferably, the hand-tearing texture anti-fake method is characterized by comprising at least one of the following.

\textcircled{1} A hand-tearing line/opening (6) is formed by die cutting beside the flat texture string (9) on the printed matter (3), so that the public can clasp one end of the flat texture string (9) by hand and tear out the flat texture string (9) to discriminate true textures from false ones.

\textcircled{2} At least one hand-tearing handle (7) or one exposed line segment (20) which can be toggled is arranged in the area where the flat texture string (9) is located on the printed matter (3), so that the public can clasp the handle (7) by hand and tear out the flat texture string (9) to discriminate true textures from false ones, or the public can toggle the exposed line segment (20) by fingers to discriminate true textures from false ones (if the flat texture string is a printed ink mark, the string cannot be toggled or torn out). In order to provide a more tactile sensation, it is preferred that the exposed line segment (20) which can be toggled is not flattened on the surface of the printing material (2).

\textcircled{3} At least one hand-tearing handle (7) is arranged in the area where the flat texture string (9) is located on the printed matter (3), and the back of the hand-tearing handle (7) is provided with an adhesive-free layer; on the contrary, if a self-adhesive layer on the back of the hand-tearing handle (7) is not removed, it is not easy to clasp the handle (7) by hand.

\textcircled{4} The fancy yarn (5) is swung continually left and right (that is, perpendicular to the length direction) during the embedding process to make the embedding position shifted left and right within a predetermined range of ≤10 mm, 5 mm, 2 mm, 1 mm, 0.5 mm or 0.3 mm; and the fancy yarn (5) is swung continually left and right during the embedding process (the purpose is to enhance the personality of the yarn and avoid local accumulation, thickening and folding after winding up).

\textcircled{5} The printed matter (3) is a product package (12). In other words, the printed matter (3) of the present invention is not limited to an independent label, but it is preferred to be printed directly on various printed packages (12).

\textcircled{6} First, the fancy yarn (5) in the printed matter (3) is super-rolled (for example, by a super calender) to make the yarn randomly deform into a flat texture string (9) with a flat shape (i.e., change from a three-dimensional structure into a nearly two-dimensional structure) and a thickness of 10-80 μm, 15-60 μm, 20-45 μm, 25-35 μm or 40-70 μm, and then the feature information of the flat texture string (9) with a flat shape is collected (for example, by photographing) as a texture information file; In this way, not only printing and subsequent processing are facilitated, the personality of the fancy yarn (5) and the individual elements (10) thereof are also enhanced, and the difficulty of faking by reproduction is increased. In other words, if the fancy yarn is not flattened, the position where the fancy yarn (5) is located on the printed matter (3) will be seriously raised, and printing and subsequent processing will be difficult to progress. Studies show that the most suitable anti-fake fiber (texture) visible to the public by naked eye is greater than 80 μm in diameter; whereas commonly used anti-fake paper has a thickness of less than 65 μm, if the fancy yarn (5) with a diameter of greater than 80 μm is embedded in thin paper with a thickness of less than 65 μm, the paper must be seriously deformed and cannot be used for printing.

\textcircled{7} The fancy yarn (5) is heated and flattened at the temperature close to the softening point thereof. This measure makes the resulting flat texture string (9) so thin that cannot be felt by hand, which can avoid the influence on printing and post-printing processing.

\textcircled{8} The fancy yarn (5) is applied with static electricity by an electrostatic generator or blown during the embedding process to make the included angle φ (11) between the length direction of the fancy yarn (5) and the personalized elements (10) thereof increase under the action of an external force (electrostatic repulsive force/wind force).

\textcircled{9} The included angle φ (11) between the length direction of the fancy yarn (5) and a plurality of personalized elements (10) is greater than or equal to 15° or 30° and less than 90°. In this way, the plurality of personalized elements (10) can be prevented from being rubbed and straightened out, stuck to the main stein of the fancy yarn (5) to shrink into one strand, and thereby losing the randomness and personalized features during the embedding process. Studies show that as long as an average of no less than 15% the personalized elements (10) such as fluff are not straightened out, the randomness and personalized features will not be lost.

\textcircled{10} The flat texture string (9) is pasted on the back of the transparent self-adhesive printed matter (3), pasted on the front of the printed matter (3) and covered and protected by a printed transparent varnish layer (13), pasted on the front of the printed matter (3) and covered and protected by a transparent transfer printing layer (13′), or embedded in the sandwich layer of a composite package (14). The transparent varnish layer (13) is also a surface layer (8).

Baidu baike explains that the composite package (14) is a multi-layer package with certain functions and made of two or more than two layers of materials which are combined together through one or a plurality of composite processes. The composite package can generally be divided into a base layer, a functional layer and a heat seal layer, wherein the base layer mainly has the functions of aesthetics, printing and moisture resistance, and is made of materials such as BOPP, BOPET, BOPA, MT, KOP and KPET; the functional layer mainly has the functions of isolation and shading, and is made of materials such as VMPET, AL, EVOH and PVDC; and the heat seal layer is in direct contact with a packaged item, has the functions of adaptability, permeation resistance, good heat sealability, etc., and is made of materials such as LDPE, LLDPE, MLLDPE, CPP, VMCPP, EVA, EAA, E-MAA, EMA and EBA. Commonly used composite packages (14) include soft bags such as salt bags, pickle bags, sanitary napkin bags and facial mask bags.

\textcircled{11} The surface layer (8) of the printed matter (3) is a transparent extinction layer, and is used to avoid interference of check and identification by reflective light;

\textcircled{12} The fancy yarn (5) is wrapped yarn, core-spun yarn, slub yarn, big-belly yarn, speck yarn, onde yarn, pigtail yarn, towel yarn, loop yarn, knot yarn, feather yarn, toothbrush yarn, pine yarn, oblique yarn, neckline yarn, track yarn, spiral yarn, centipede yarn, tape yarn, fiber yarn, chain yarn, metallic yarn, wired yarn, heather yarn, chine yarn, rainbow yarn, folded yarn, textured yarn or combination yarn. In short, all kinds of fancy yarn (5) with obvious features of personalized elements (10) (easy to be recognized by naked eye) can be flattened and shaped to form the flat texture string (9).

\textcircled{13} The feature information of one or a plurality of segments with a length of L of the flat texture string (9) on the printed matter (3) is collected and stored in an anti-fake check system database as a texture information file, wherein L is 3-30 mm, 3-90 mm or 3-300 mm.

\textcircled{14} The feature information of the flat texture string (9) in a viewing area (15) on the printed matter (3) is collected and stored in an anti-fake check system database (of a computer connected to the Internet) as a texture information file.

\textcircled{15} The printing material (2) required for the printed matter (3) and embedded with the hot melt fancy yarn (5) is heated to the temperature close to the melting point of the hot melt fancy yarn (5) and super-rolled to make the hot melt fancy yarn (5) randomly deform into the flat texture string (9) with a flat shape and a thickness of 10-45 μm or 25-35 μm, and after the shape of the flat texture string (9) is stable, the feature information of the flat texture string (9) with a flat shape is collected as a texture information file.

\textcircled{16} The information (content) made public comprises the meaning such as that: a product of which the personalized elements (10) remain on the printed matter (3) after the main stem of the fancy yarn (5) is torn out is false.

\textcircled{17} Preferably, the width M of the flat texture string (9) is 0.01-15 mm, and the length L is 3-30 mm, 3-90 mm or 3-300 mm. The width M of the flat texture string (9) of the present invention refers to the width of the narrow area occupied by the flat texture string (9), including the narrow area where all the personalized elements (10) in the flat texture string (9) are distributed.

The hand-tearing texture anti-fake product of the present invention has the following technical solution.

A hand-tearing texture anti-fake product, comprising a printed matter (3) and a random structural texture (1) thereof, wherein a unique code (4) is printed on the printed matter (3), and the feature information of the random structural texture (1) is collected and stored in correspondence to the code (4) in an anti-fake check system database as an anti-fake feature information file of the printed matter (3); and characterized in that: fancy yarn (5) is embedded under a transparent (including translucent) surface layer (8) on the printed matter (3); the fancy yarn (5) and personalized elements (10) thereon are flattened (i.e., in a flat shape) and shaped, and thereby forming a line string of the random structural texture (1) with a flat and stable shape—called a flat texture string (9) for short; the thickness of the area where the flat texture string (9) is located on the printed matter (3) is greater than the surrounding area by 0-80 μm, 20-75 μm, 30-73 μm, 40-70 μm or 50-68 μm; and the feature information of the flat texture string (9) is collected and stored in an anti-fake check system database as an anti-fake feature information file of the printed matter (3). The width M of the flat texture string (9) is preferred to be 0.1-18 mm.

Preferably, the hand-tearing texture anti-fake product is characterized by comprising at least one of the following.

\textcircled{1} A hand-tearing line/opening (6) is formed by die cutting beside the flat texture string (9) on the printed matter (3).

\textcircled{2} At least one hand-tearing handle (7) or one exposed line segment (20) which can be toggled is arranged in the area where the flat texture string (9) is located on the printed matter (3). In order to provide a more tactile sensation, the exposed line segment (20) which can be toggled is knot flattened on the printed matter (3).

\textcircled{3} The back of the hand-tearing handle (7) is provided with an adhesive-free layer.

\textcircled{4} The flat texture string (9) is embedded within a predetermined range of ≤10 mm, 5 mm, 2 mm, 1 mm, 0.5 mm or 0.3 mm.

\textcircled{5} The printed matter (3) is a product package (12).

\textcircled{6} The flat texture string (9) is flattened to a thickness of 10-80 μm, 15-60 μm, 20-45 μm, 25-35 μm or 40-70 μm; the width M of the flat texture string (9) is greater than or equal to 200 μm, 500 μm or 1200 μm; in other words, the flat texture string (9) is flattened to change from a three-dimensional structure into a two-dimensional structure; and studies show that the thickness is preferred, to be 25-35 μm, because the flat texture string is difficult to be felt by hand when the thickness is less than 10 μm and is difficult to be printed and processed when the thickness is greater than 80 μm.

\textcircled{7} The included angle φ (11) between the length direction of the fancy yarn (5) and a plurality of personalized elements (10) thereon is greater than or equal to 15° or 30° and less than 90°.

\textcircled{8} The flat texture string (9) is pasted on the back of the transparent self-adhesive printed matter (3), pasted on the front of the printed matter (3) and covered and protected by a printed transparent varnish layer (13), pasted on the front of the printed matter (3) and covered and protected by a transparent transfer printing layer (13′), or embedded in the sandwich layer of a composite package (14).

\textcircled{9} When the shape of the personalized elements (10) is a circle or point, the diameter of the circle or point is 0.1-3 mm, 0.2-2 mm or 1-2 mm; or when the shape of the personalized elements (10) is a line, the width of the line is greater than or equal to 0.03 mm, 0.05 mm, 0.07 mm or 0.10 mm, and the length of the line is 0.3-0.7 mm, 0.3-1.2 mm, 0.3-1.8 mm, 0.3-3 mm or 0.3-5 mm.

\textcircled{10} The fancy yarn (5) is loop yarn with a loop diameter of 0.1-3 mm, 0.2-2 mm or 1-2 mm, and a loop density of 2-20 loops/cm. In other words, if the density is too low, a relatively small printed matter (3) is easily left blank (i.e., no loops); and if the density is too high, the loops on the printed matter (3) are easy to pile up and difficult to print. Therefore, it is preferred to have 2-20 loops per centimeter along the length direction of the fancy yarn (5).

\textcircled{11} Preferably, the fancy yarn (5) is wrapped yarn, core-spun yarn, slub yarn, big-belly yarn, speck yarn, onde yarn, pigtail yarn, towel yarn, loop yarn, knot yarn, feather yarn, toothbrush yarn, pine yarn, oblique yarn, neckline, yarn, track yarn, spiral yarn, centipede yarn, tape yarn, fiber yarn, chain yarn, metallic yarn, wired yarn, heather yarn chine yarn, rainbow yarn, folded yarn, textured yarn or combination yarn of the above.

\textcircled{12} The flat texture string (9) and the surface layer (8) are not bonded by adhesive; or the flat texture string (9) and, a bottom layer (19) are not bonded by adhesive. For example, the flat texture string (9) is bonded with the bottom layer (19) by adhesive, but is not bonded with the surface layer (8). In this way, when the flat texture string (9) is torn out for check, the individual elements (10) thereon can be identified as real or not.

Preferably, the loop yarn is three-strand yarn, wherein at least two strands of yarn have different colors, and it is preferred that all the three strands of yarn have different colors; single yarn constituting the same strand of yarn is formed by twisting at least two fiber bundles with different colors in the loop yarn; or the exposed line segment (20) which can be toggled is not flattened on the printed matter (3). In this way, the personalized features of the flat texture string (9) will be obviously enhanced, the difficulty of faking will be increased, and identification will become easier and more accurate.

The code (4) of the present invention generally refers to various codes, such as a serial number, a one-dimensional bar code, a two-dimensional code, a production date, an anti-fake code, an anti-channeling code and a commodity traceability code, and is preferred to be a two-dimensional code which has uniqueness and randomness and contains the URL of a query link.

The flat texture string (9) of the present invention is a segment of line with obvious personalized features and collectively presented by the randomly distributed personalized elements (10) such as details connected in series to the fancy yarn (5) when the fancy yarn (5) is embedded in the printed matter (3) and flattened. The personalized elements (10) such as details can be curves with random shapes (such as bent and spiral curves), knots, branches, fluff, burrs, edge threads, decorative patterns, nodes, specks, thread residues, loops, twisted edges, etc. The personalized elements (10) are equivalent to the dispersed short fibers, chips, irregularly shaped particles, bubbles and sundries which can produce the internal structural texture of a carrier material in the “Structural Texture Anti-fake Method (CN1074563C)” and the “Structural Texture Anti-fake Marker (CN2365711Y)”. The flat texture string (9) collectively presented by the personalized elements (10) is equivalent to the random structural texture (1) in the “Structural Texture Anti-fake Method (CN1074563C)”, and is an anti-fake and identification feature easy to be checked by hand tearing.

The fancy yarn (5) of the present invention includes not only the yarn defined by the national standards of textile industry, but also the yarn with visible personalized features within a certain length L.

The hand-tearing texture anti-fake material of the present invention has the following technical solution.

A hand-tearing texture anti-fake material, comprising a printing material (2) and a random structural texture (1) thereof, and characterized in that: fancy yarn (5) is embedded under a transparent (including translucent) surface layer (8) on the printing material (2); the fancy yarn (5) and personalized elements (10) thereon are flattened (i.e., in a flat shape) and shaped, and thereby forming a line string of the random structural texture (1) with a flat and stable shape—called a flat texture string (9) for short; and the thickness of the area where the flat texture string (9) is located on the printing material (2) is greater than the surrounding area by 2-80 μm, 20-75 μm, 30-73 μm, 40-70 μm or 50-68 μm. The width M of the flat texture string (9) is preferred to be 0.1-18 mm.

Preferably, the hand-tearing texture anti-fake material is characterized by comprising at least one of the following.

\textcircled{1} The flat texture string (9) is embedded within a predetermined range of ≤10 mm, 5 mm, 2 mm, 1 mm, 0.5 mm or 0.3 mm.

\textcircled{2} The fancy yarn (5) and personalized elements (10) thereon are flattened and shaped into a flat texture string (9) with a thickness of 10-80 μm, 15-60 μm, 20-45 μm, 25-35 μm or 40-70 μm; and the width M of the flat texture string (9) is greater than or equal to 200 μm, 500 μm, 1200 μm or the thickness of the printing material (2).

\textcircled{3} The included angle φ (11) between the length direction of the fancy yarn (5) and a plurality of personalized elements (10) thereon is greater than or equal to 15° or 30° and less than 90°.

\textcircled{4} The flat texture string (9) is embedded in the sandwich layer of the composite material.

\textcircled{5} Fancy yarn (5) randomly bending is embedded in the printing material (2).

\textcircled{6} When the shape of the personalized elements (10) is a circle or point, the diameter of the circle or point is 0.1-3 mm, 0.2-2 mm or 1-2 mm; or when the shape of the personalized elements (10) is a line, the width of the line is greater than or equal to 0.03 mm, 0.05 mm, 0.07 mm or 0.10 mm, and the length of the line is 0.3-0.7 mm, 0.3-1.2 mm, 0.3-1.8 mm, 0.3-3 mm 0.3-5 mm.

\textcircled{7} The fancy yarn (5) is loop yarn with a loop diameter of 0.1-3 mm, 0.2-2 mm or 1-2 mm, and a loop density of 2-20 loops/cm. In other words, if the density is too low, a relatively small printed matter (3) is easily left blank (i.e., no loops); and if the density is too high, the loops on the printed matter (3) are easy to pile up and difficult to print. Therefore, it is preferred to have 2-20 loops per centimeter along the length direction of the fancy yarn (5).

\textcircled{8} The fancy yarn (5) is hot melt yarn with the melting point lower than 85° C. or 110° C. In this way, when heated and rolled, the fancy yarn (5) will be more easily flattened or even planished, which is beneficial to printing and post processing.

\textcircled{9} Preferably, the loop yarn is three-strand yarn, wherein at least two strands of yarn have different colors, and it is preferred that all the three strands of yarn have different colors; or single yarn constituting the same strand of yarn is formed by twisting at least two fiber bundles with different colors in the loop yarn. In this way, the personalized features of the flat texture string (9) will be obviously enhanced the difficulty of faking will be increased, and identification will become easier and more accurate. Studies show that the flat texture string (9) formed after super rolling of the printing material (2) embedded in the loop yarn can become completely stable only after standing for more than 3 hours at room temperature; in other words, the flat texture string cannot be used immediately after rolling, nor can the feature information of the flat texture string be photographed and collected too early.

\textcircled{10} The flat texture string (9) and the surface layer (8) are not bonded by adhesive; or the flat texture string (9) and a bottom layer (19) are not bonded by adhesive. For example, the flat texture string (9) is bonded with the bottom layer (19) by adhesive, but is not bonded with the surface layer (8). In this way, when the flat texture string (9) is torn out for check, the individual elements (10) thereon can be identified as real or not.

Preferably, a plurality of exposed line segments (20) which can be toggled are arranged on the surface of the printing material (2); or a plurality of exposed line segments (20) which are not flattened and can be toggled are arranged on the surface of the printing material (2).

The product package (12) of the present invention includes printed items such as product description, product certificate, product tag, product label and packaging tape.

Compared with the prior art, the present invention can yield the following beneficial effects.

First, the flat texture string (9) in the printed matter (3) is relatively long and strong, so the public can tear the main stem of the fancy yarn (5) and bring out the personalized elements (10) thereof by hand, and discriminate true textures from false ones by checking whether the fancy yarn (5) and the personalized elements (10) thereof can be torn out and whether all the personalized elements (10) remain on the printed matter (3); in other words, if the personalized elements (10) are faked by printing, after the real main stem is torn out, all the ink mark of the faked personalized elements (10) inevitably remain on the printed matter (3). The public can toggle the exposed line segment by fingers to discriminate true textures from false ones by checking whether the fancy yarn (5) and the personalized elements (10) thereof can be toggled. The, present invention can overcome the disadvantages of discriminating true textures from and false ones by needle picking, greatly improve the participation rate of the public in discriminating the authenticity of commodities, greatly improve the public supervision, effectively curb the circulation of fake commodities, and overcome the application problems that have troubled the texture anti-fake industry in China for more than ten years. In other words, the personalized elements (10) equivalent to the random structural texture (1) in the background art is pulled out by hand, without the need of using a sharp object such as a needle to pick out and check.

Second, the personalized elements (10) in the present invention cannot be restored after being torn out, which can prevent faking by recycling. In contrast, the short fibers in the current texture paper showing the texture are dispersed in the paper independently, just like a heap, of loose sand; whereas all the personalized elements (10) in the present invention are connected in series to the main stem of the fancy yarn (5), just like grasshoppers tied to the same rope, and are in a whole, so the personalized elements are easy to be torn out and checked by hand. In other words, the present invention creatively adopts the technical measure of stringing together short fibers (texture) which were originally dispersed (in the paper) to produce a flat texture string (9), and thereby can overcome the disadvantages of needle-picking fibers (texture) and achieve the purpose of line string texture.

Third, in the present invention, the fancy yarn (5) and the personalized elements (10) thereon are not simply regarded as anti-fake features and directly used, but the relatively thick personalized elements (10), such as fluff, thread residues, branches, loops, knots and specks, of a three-dimensional structure on the fancy yarn (5) are flattened into a two-dimensional structure, shaped and made into new personalized features such as the flat texture string (9), and then used as the random structural texture (1) required for anti-fake. This innovative technical achievement solves a plurality of technical contradictions, overcomes the technical defect that fancy yarn (5) is easy to make the printing material uneven (unusable), and costs the inventor of this application more than ten years of research and development time and funds, which is not easy to come by.

Fourth, in the present invention, when manufacturing the printing material (2) (equivalent to the texture paper) required for the printed matter (3), it is only necessary to pull the fancy yarn (5) out of a line releasing reel, embed the fancy yarn between two layers of pulp, and roll fancy yarn; the process of mixing fibers into the pulp can be omitted, so that no contamination of the production environment, such as the pulp pool, pulp pipeline, paper machine and waste pulp recovery pool, will be caused by fibers. The situation of “spending two days for papermaking, but three days for cleaning” will not happen, which can improve the production efficiency, reduce the production cost, and avoid the contamination of the workshop environment.

Fifth, the flattened and shaped flat texture string (9) is a randomly shaped personalized anti-fake feature, and the deformation thereof cannot be controlled by human power, so the flat texture string cannot be pasted and faked manually. Compared with the “Structural Texture Anti-fake Marker (CN2365711Y)”, the anti-fake capability is increased. Studies show that the hand-tearing texture anti-fake product of the present invention cannot be reproduced, and the anti-fake capability is higher than the highest national standard (GB/T19425-2003). Whereas the short fibers (texture) in the background art are often pasted and faked manually by fakers in real applications.

Sixth, the popularization and application of the present invention will inevitably improve the anti-fake application effect, and the public will actively conduct anti-fake queries subjectively, which will inevitably and greatly improve the anti-fake query rate. Therefore, the commodity retail big data such as commodity circulation and sales dynamics is objectively collected by the anti-fake check system, which is very beneficial to the development of the commodity big data industry in China.

### DESCRIPTION OF THE DRAWINGS

FIG. 1 is a schematic diagram of a printed matter (brushed yarn type) embodiment 1 of the present invention.

FIG. 2 is a schematic diagram of a printed matter (loop yarn type) in embodiment 2 of the present invention.

FIG. 3 is a schematic diagram of a printed matter wrapped toothbrush yarn type) in embodiment 3 of the present invention.

FIG. 4 is a schematic diagram of a printed matter (feather yarn type) in embodiment 4 of the present invention.

FIG. 5 is a schematic diagram of a printed matter (colorful braid yarn type) in embodiment 5 of the present invention.

FIG. 6 is a schematic diagram of a printed matter (cotton-bamboo fiber iceland yarn type) in embodiment 6 of the present invention.

FIG. 7 is a schematic diagram of a printed matter (two-color wrapped yarn type) in embodiment 7 of the present invention.

FIG. 8 is a schematic diagram of a printed matter multi-yarn type) in embodiment 8 of the present invention.

FIG. 9 is a schematic diagram of a printed matter towel yarn type) in embodiment 9 of the present invention.

FIG. 10 is a segmental view of positions of dotted lines in FIG. 9.

FIG. 11 is a schematic diagram of an anti-fake material (brushed yarn type) used in embodiment 1 of the present invention.

FIG. 12 is a schematic diagram of an anti-fake material (loop yarn type/textured yarn type) used in embodiment 2 of the present invention.

FIG. 13 is a schematic diagram of an anti-fake material (wrapped, toothbrush yarn type) used in embodiment 3 of the present invention.

FIG. 14 is a schematic diagram of an anti-fake material (feather yarn type) used in embodiment 4 of the present invention.

FIG. 15 is a schematic diagram of an anti-fake material (colorful braid yarn type) used in embodiment 5 of the present invention.

FIG. 16 is a schematic diagram of an anti-fake material (cotton-bamboo fiber, iceland yarn type) used in embodiment 6 of the present invention.

FIG. 17 is a schematic diagram of an anti-fake material (two-color wrapped yarn type) used in embodiment 7 of the present invention.

FIG. 18 is a schematic diagram of integrated application of a printed matter and a product package (such as a medicine box) in embodiment 10 of the present invention.

FIG. 19 is a schematic diagram of a small angle between a main stem of a fancy yarn (5) and a personalized element in the present invention.

FIG. 20 is a schematic diagram after an angle between a main stem of a fancy yarn (5) and a personalized element of FIG. 19 is enlarged by an external force.

FIG. 21 is a schematic diagram of a printed matter scanned/photoed and inspected using a smartphone in an embodiment of the present invention.

FIG. 22 is a schematic diagram of a printed matter (fiber cable type) in embodiment 11 of the present invention.

FIG. 23 is a schematic diagram of current full-version texture (fiber) paper.

FIG. 24 is a schematic diagram of a printed matter (back-yarn type) in embodiment 12 of the present invention.

FIG. 25 is a segmental view of positions of dotted lines in FIG. 24.

FIG. 26 is a schematic diagram of a printed matter (front-yarn type) in embodiment 13 of the present invention.

FIG. 27 is a segmental view of positions of dotted lines in FIG. 26.

FIG. 28 is a (partial) schematic diagram of a composite package in embodiment 14 of the present invention.

FIG. 29 is a segmental view of positions of dotted lines in FIG. 28.

FIG. 30 is a schematic diagram of a composite package (of a board of medicine) in embodiment 15 of the present invention.

FIG. 31 is a schematic diagram of a printed matter (randomly bent yarn type in embodiment 16 of the present invention.

FIG. 32 is a schematic diagram of an anti-fake material (textured yarn type) in an embodiment of the present invention.

FIG. 33 is a schematic diagram of a flattening and setting process in Embodiment 18 of the present invention.

FIG. 34 is a schematic diagram of a flattening and shaping technology in embodiment 19 of the present invention.

FIG. 35 is a schematic diagram of a printed matter with exposed line segments in embodiment 20 of the present invention.

FIG. 36 is a schematic diagram of another printed matter with exposed line segments in embodiment 20 of the present invention.

Description of reference numerals: 1—random structural texture, 2—printing material, 3—printed matter, 4—code, 5—fancy yarn, 6—hand-tearing line/opening, 7—hand-tearing handle, 8—surface layer, 9—flat texture string, 10—personalized element, 11—angle φ, 12—product package, 13—transparent varnish layer, 13′—transparent transfer printing layer (also known as transfer layer/hot stamping layer), 14—composite package, 15—viewing area, 16—hot pressing roller, 17—bottom roller, 18—composite roller, 19—bottom layer, 20—exposed line segment, and 21—window.

### DETAILED DESCRIPTION

In order to make the above purposes, features and advantages of the present invention more clear and easier to understand, the comprehensive preferred embodiments of the present invention are described below, and the accompanying drawing are also used for detailed description.

### Embodiment 1

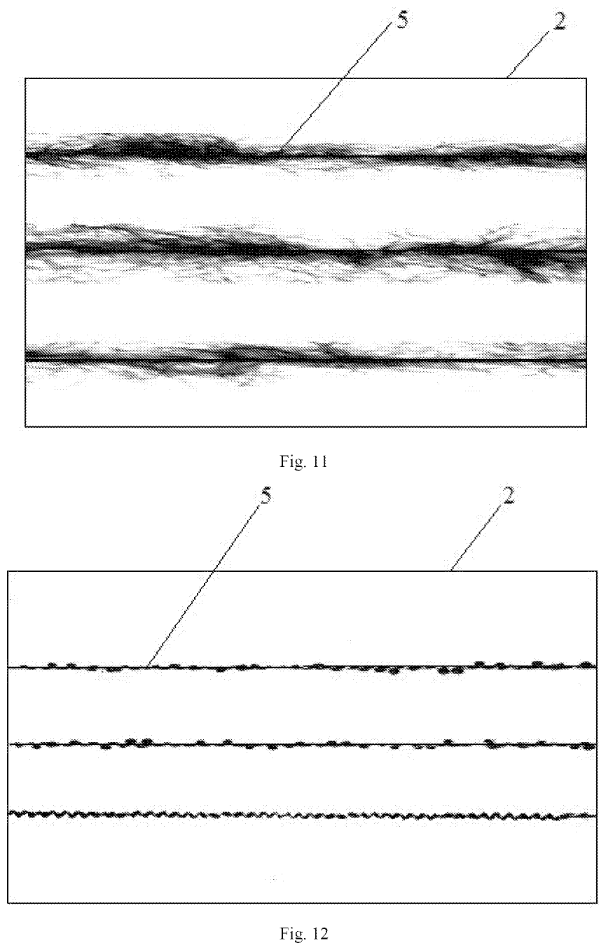

As shown in FIG. 11, by referring to the composite production technology of the utility model patent “Laser Holographic Safety Line Composite Packaging Box (CN2399334Y)”, the surface layer of a transparent BOPP film is combined with a white PE bottom layer, and at the same time, a strand of 7×0.5 D black polyester brushed yarn-fancy yarn is pulled out from a spinning reel and buried between the two layers, and rolled to deform (flattened) by a supercalender to ensure that all the feathers thereon are stuck, clamped and fixed, so as to manufacture the printing material of the fancy yarn including the brushed yarn.

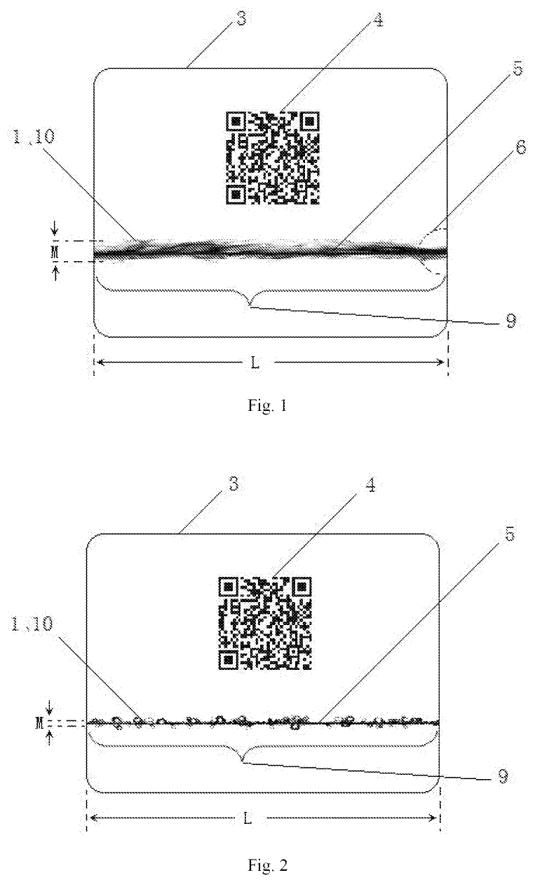

As shown in FIG. 1, the printed matter is printed using the above brushed yarn type printing material, and a unique sequence code (i.e., code) including a link address is printed for each printed matter by using a coding machine.

An industrial-grade digital camera is prepared. After the stress of a flat texture string, is released and the shape is completely set, each code and a segment of long and narrow (partial/non-full version) flat texture string in each printed matter in the vicinity which is composed of the fancy yarn and the feathers and other personalized elements with the length L and the width M and which runs through the entire printed matter are shot to obtain file photos; then, the shot file photos about a segment of flat texture string in each printed matter and the corresponding code information (i.e., index code information) are stored in an anti-fake inspection system database as a basis for authenticity verification-texture information file.

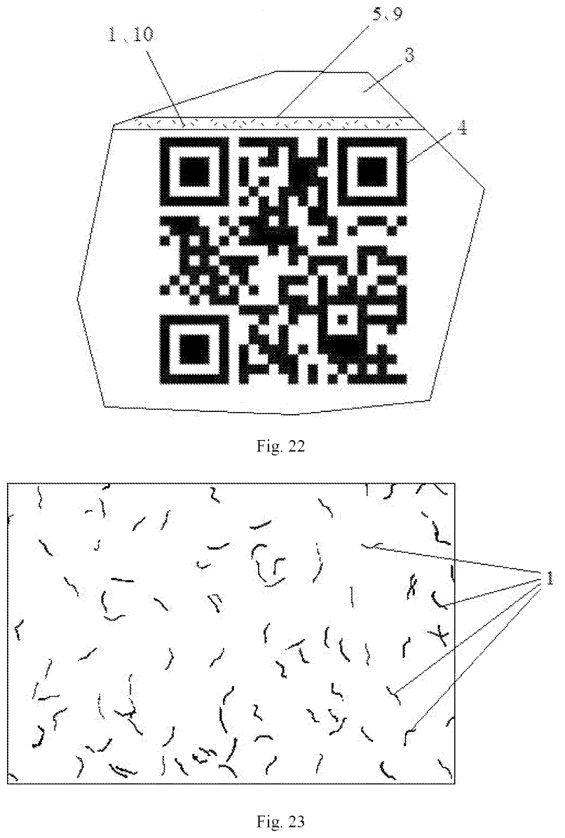

If the public wants to identify the authenticity, as shown in FIG. 21, a camera phone with a lens resolution of ≥5 million pixels can be used to take a photo of the code and the flat texture string nearby-the information to be inspected. The information to be inspected and the code information are uploaded together (including sending via SMS or WeChat) to the anti-fake inspection system database, and the anti-fake inspection system matches (identifies) the texture information of the flat texture string on the information to be inspected with the texture information file in the database. If matched, the information that the authentication conclusion is true is fed back to the camera phone; if not matched, the information that the authentication conclusion is false is fed back to the camera phone. Of course, the WeChat scanning software in the camera phone can also be used to scan the QR code (i.e., the code) shown in FIG. 11 to start the link, browse and view the photo file in the database, and check whether the features of a segment of flat texture string with the length L and the width M are consistent with the photo file, so as to identify the authenticity.

If the code is a copied fake logo, the fake flat texture string is inevitably unable to be extracted and verified like a real solid line because the fake flat texture string is ink. Thus, both the user and the anti-fake inspection system should announce to the public:—If the flat texture string is not consistent with the texture information file, the printed matter inspected is false;—If the flat texture string is consistent with the texture information file, and the flat texture string of the printed matter inspected is a real object that can be extracted (also called as torn out/pulled out, etc.), instead of printing ink, the printed matter inspected is true, otherwise is false.

After the public sees the announcement (also known as a warning), the public can tear the main stem of fancy yarn and bring out the personalized element with hands. The true and false textures can be identified to judge whether the fancy yarn and the personalized element can be torn out and whether all the personalized elements remain in the printed matter. In other words, if the personalized elements are faked by printing, after the real main stem is torn out, all the ink mark of the faked personalized elements inevitably remain on the printed matter.

According to the specific requirements of the user, the fancy yarn of some printed matters is allowed to be thicker. In this way, the fancy yarn can be touched by hands to perceive the existence of the fancy yarn and the flat texture string without the need for hand tearing for inspection.

The personalized elements such as feathers described in the present embodiment are equivalent to the fibers that form a random structural texture in the “Structural Texture Anti-fake Method (CN1074563C)”.

### Embodiment 2

As shown in FIG. 12, the first and second strands are loop yarn and the third is textured yarn, both of which are fancy yarn. The yarn is pulled out of the spinning reel, embedded between two layers of paper pulp at a certain spacing, and rolled to deform (flattened) by using a supercalender, so as to manufacture a fancy yarn printing material embedded with the loop yarn and the textured yarn. The printing material can be used to print the printed matter shown in FIG. 2. Other steps can be the same as those of embodiment 1.

### Embodiment 3

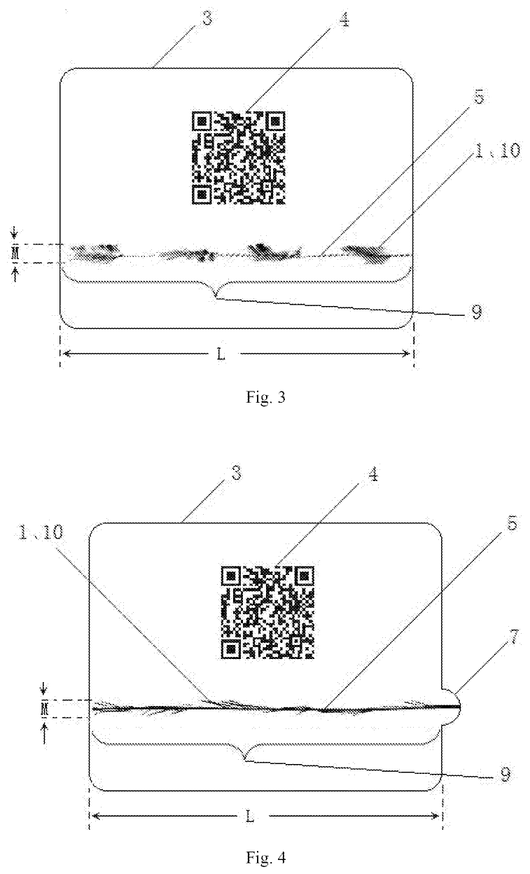

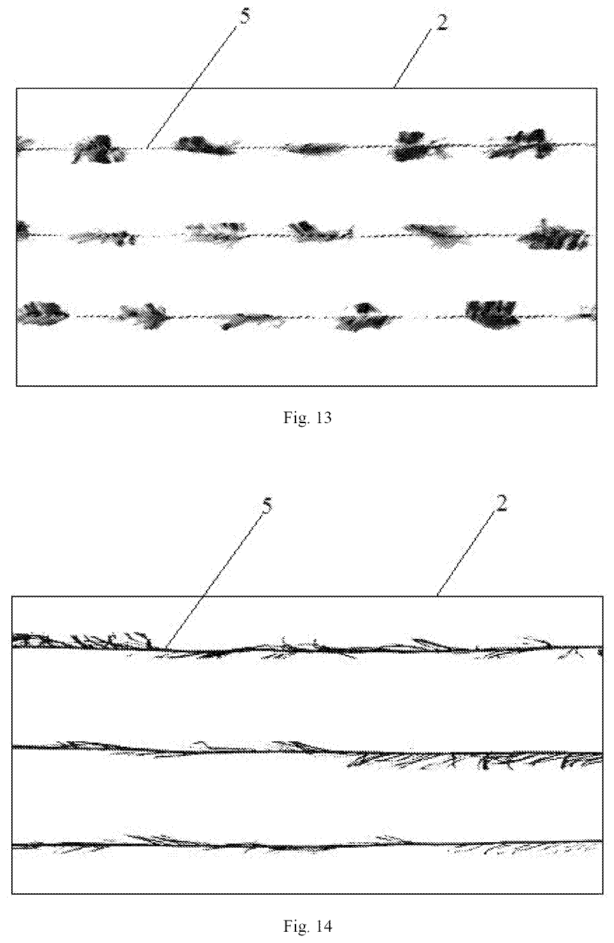

As shown in FIG. 13, bunches of colored wrapped toothbrush yarn-fancy yarn are pulled out from the spinning reel, embedded between two layers of paper pulp at a certain spacing, and rolled to deform (flattened) by using a supercalender, with the flattened flat texture string having a thickness of preferably 25-35 μm, so as to manufacture a fancy yarn printing material embedded with the wrapped toothbrush yarn. The printing material can be used to print the printed matter shown in FIG. 3. Other steps can be the same as those of embodiment 1.

### Embodiment 4

As shown in FIG. 14, by referring to the composite production technology of the Chinese utility model “Laser Holographic Safety Line Composite Packaging Box (CN2399334Y)”, bunches of black polyester feather yarn-fancy yarn are pulled out from the spinning reel, embedded between two layers at a certain spacing, and rolled to deform (flattened), with the flattened flat texture string having a thickness of preferably 10-25 μm, to ensure that all the feathers thereon are stuck, clamped and fixed, so as to manufacture a fancy yarn printing material embedded with the feather yarn.

As shown in FIG. 4, the printed matter is printed using the above printing material embedded with the feather yarn, and a unique sequence code (i.e., code) including a link address is printed for each printed matter by using a coding machine.

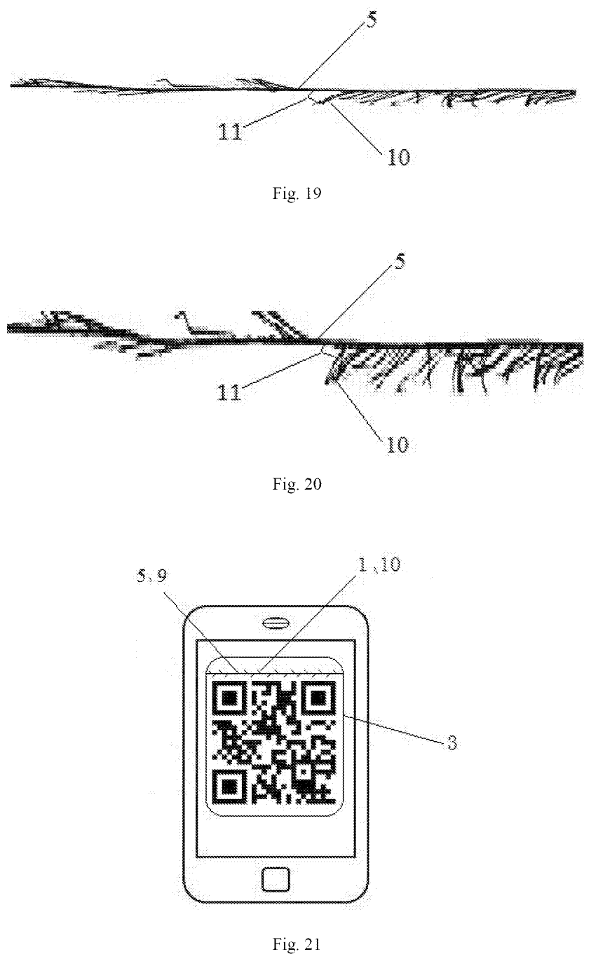

Preferably, as shown in FIG. 19 and FIG. 20, in the process of embedding the fancy yarn into the printing material, an electrostatic generator is used to apply static electricity to the fancy yarn or the fancy yarn is blown with side wind to increase the angle φ between the main stem of the fancy yarn in the printing material and the personalized elements such as feathers by the action of an external force. The angle φ between the main stem of the fancy yarn in the printing material and 20% or 30% or 50% or more of feather-type personalized elements is preferably ≥15° or 30° or 45°. In this way, the feather-type personalized elements can be prevented from being rubbed and smoothed and completely stuck to the main stem of fancy yarn and shrunk into a strand without losing randomness and personalized features of the fancy yarn in the embedding process.

An industrial-grade digital camera is prepared. Each code and a segment of fancy yarn (flat texture string) in each printed matter nearby are shot to obtain file photos; then, the shot file photos about a segment of flat texture string in each printed matter and the corresponding code information (i.e., index code information) are stored in an anti-fake inspection system database as a basis for authenticity verification so that the public can check the authenticity.

If the public wants to identify the authenticity, as shown in FIG. 21, a camera phone with a lens resolution of ≥5 million pixels can be used to take a photo of the code and the flat texture string nearby-the information to be inspected. The information to be inspected and the code information are uploaded together (including sending via SMS or WeChat) to the anti-fake inspection system database, and the anti-fake inspection system matches (identifies) the texture information of the flat texture string on the information to be inspected with the texture information file in the database. If matched, the information that the authentication conclusion is true is fed back to the camera phone; if not matched, the information that the authentication conclusion is false is fed back to the camera phone. Of course, the WeChat scanning software in the camera phone can also be used to scan the QR code (i.e., the code) shown in FIG. 11 to start the link, browse and view the photo file in the database, and check whether the personalized features of a segment of flat texture string with the length L and the width M are consistent with the photo file, so as to identify the authenticity.

If the code is a copied fake logo, the fake flat texture string is inevitably unable to be extracted and verified like a real solid line because the fake flat texture string is ink. Thus, both the user and the anti-fake inspection system should announce to the public:—If the flat texture string is not consistent with the texture information file, the printed matter inspected is false;—If the flat texture string is consistent with the texture information file, and the flat texture string of the printed matter inspected is a real object that can be extracted (also called as torn out/pulled out, etc.), instead of printing ink, the printed matter inspected is true, otherwise is false.

After the public sees the announcement (also known as a warning), most people take actions: tear out the flat texture string with hands, destructively check whether a flat texture string exists in the printed matter, and finally determine the authenticity. The personalized elements such as feathers described in the present embodiment are equivalent to the fibers that form a random structural texture in the “Structural Texture Anti-fake Method (CN1074563C)”.

### Embodiment 5

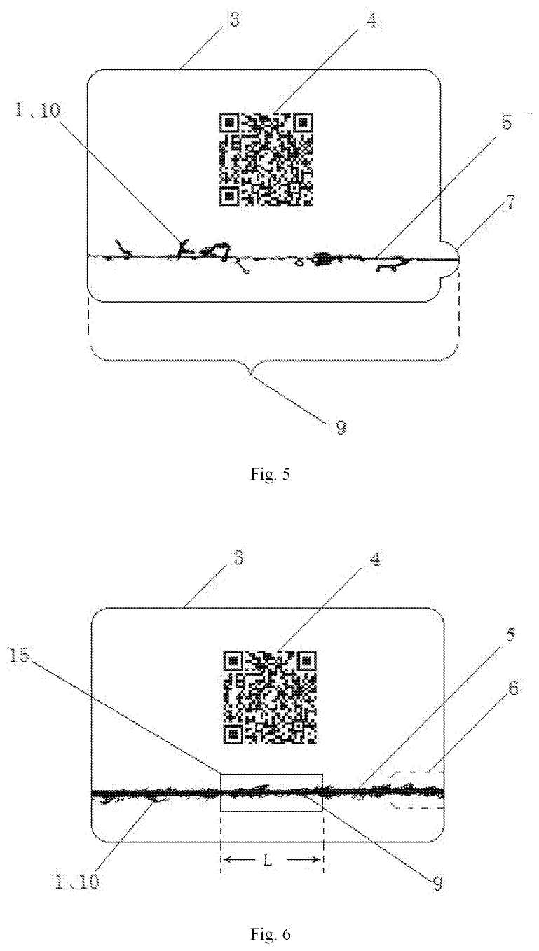

As shown in FIG. 15, bunches of colored braided yarn-fancy yarn are pulled out from the spinning reel, and embedded between two layers of paper pulp at a certain spacing, so as to manufacture a fancy yarn printing material embedded with the colored braided yarn. The printing material can be used to print the printed matter shown in FIG. 5. Other steps can be the same as those of embodiment 1.

### Embodiment 6

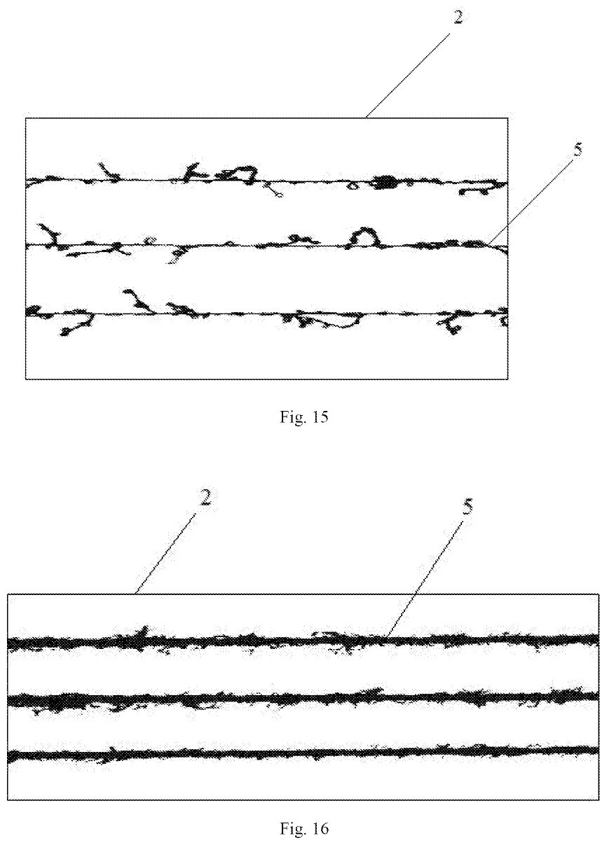

As shown in FIG. 16, bunches of cotton-bamboo fiber icelandic yarn-fancy yarn are pulled out from the spinning reel, and embedded between two layers of paper pulp at a certain spacing, so as to manufacture a fancy yarn printing material embedded with the cotton-bamboo fiber icelandic yarn. The printing material can be used to print the printed matter shown in FIG. 6. In order to facilitate the public to observe and verify the authenticity, it is best to print a viewing area on the printed matter to circle a flat texture string from the fancy yarn, only collect the feature information of the flat texture string in the viewing area and store the information as the texture information file into the anti-fake inspection system database (computer connected to the Internet). Other steps can be the same as those of embodiment 1.

### Embodiment 7

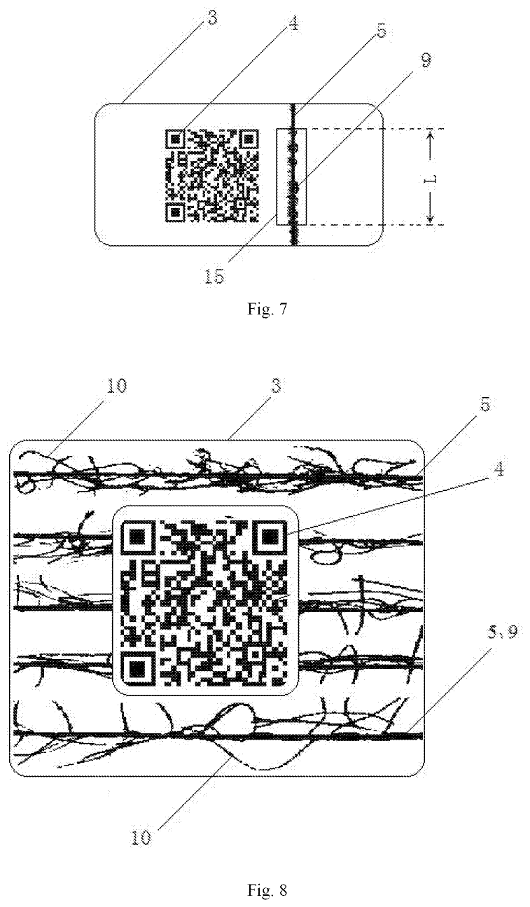

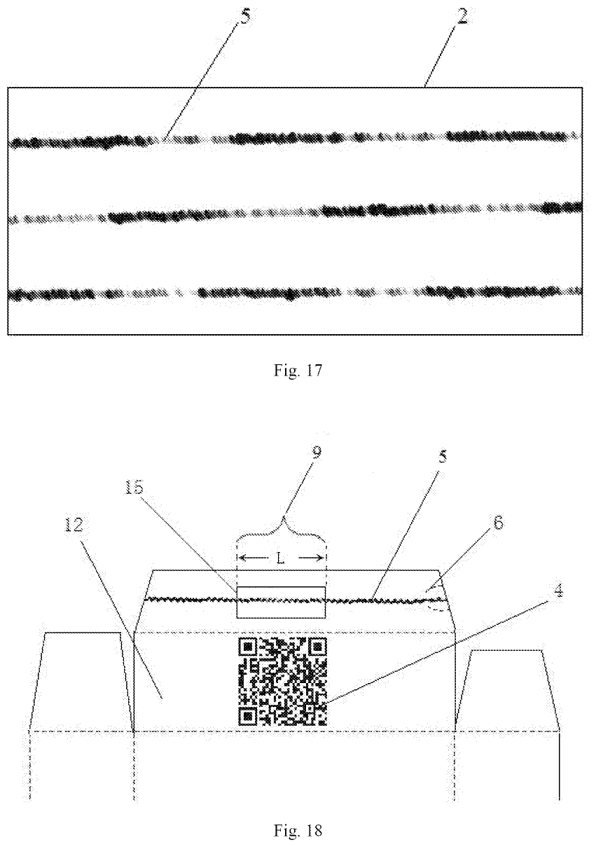

As shown in FIG. 17, bunches of two-color wrapped yarn-fancy yarn are pulled out from the spinning reel, and embedded between two layers of paper pulp at a certain spacing, so as to manufacture a fancy yarn printing material embedded with the two-color wrapped yarn. The printing material can be used to print the printed matter shown in FIG. 7. In order to facilitate the public to observe and verify the authenticity, it is best to print a viewing area on the printed matter to circle a flat texture string from the fancy yarn, only collect the feature information of the flat texture string in the viewing area and store the information as the texture information file into the anti-fake inspection system database (computer connected to the Internet). Other steps can be the same as those of embodiment 1.

### Embodiment 8

As shown in FIG. 17, bunches of fancy yarn are pulled out from the spinning reel, and embedded between two layers of paper pulp at a certain spacing, so as to manufacture a printing material embedded with the fancy yarn. The printing material can be used to print the printed matter shown in FIG. 8, and the printed matter has a plurality strands of fancy yarn. Other steps can be the same as those of embodiment 1.

### Embodiment 9

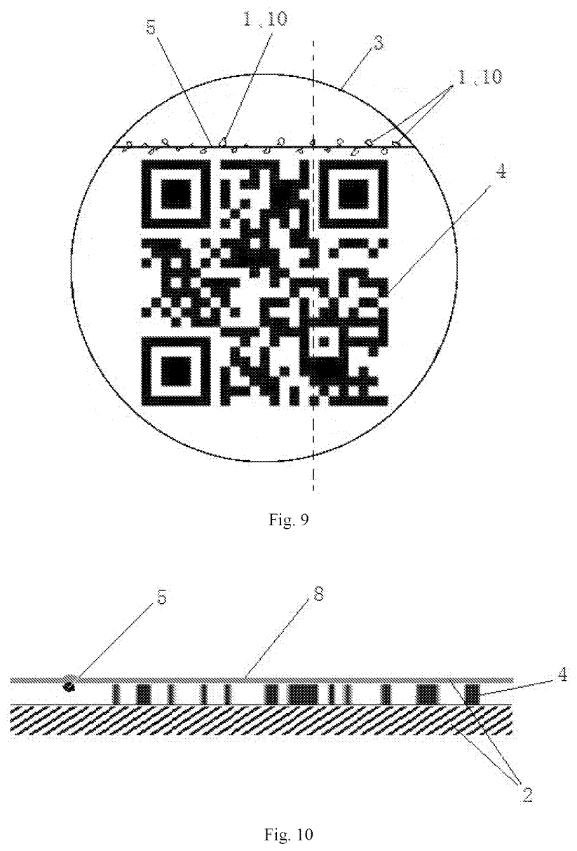

As shown in FIG. 9 and FIG. 10, the printed matter is printed with 80 g/m² white coated paper sticker material. Firstly, a unique two-dimensional code (i.e., code) is printed on the front surface. Then, bunches of towel yarn-fancy yarn are pulled out from the spinning reel, and put beside the two-dimensional code of the coated paper according to the spacing of the printed matter. Then, a laminating unit is used to coat the matte transparent BOPP prepared in advance to serve as the surface layer of the printed matter. Finally, the surface layer is die-cut and discarded, so as to manufacture pieces of printed matter sandwiched with the towel yarn. The thickness of the flattened towel yarn flat texture string is preferably 30-40 μm, and other steps are the same as above.

### Embodiment 10

As shown in FIG. 18, 230 g/m² white cardboard is used to print a medicine box. Firstly, a unique two-dimensional code (i.e., code) is printed on the front surface. Then, bunches of textured yarn-fancy yarn are pulled out from the spinning reel, and put beside the two-dimensional code of the white cardboard according to the spacing of the medicine box. Then, a laminating unit is used to coat the matte transparent BOPP prepared in advance to serve as the surface layer of the medicine box. Finally, the surface layer is die-cut and discarded, so as to manufacture pieces of anti-fake medicine boxes with textured yarn and personalized elements. In order to facilitate the public to observe and verify the authenticity, it is best to print a viewing area on the medicine box to circle a flat texture string from the fancy yarn, only collect the feature information of the flat texture string in the viewing area and store the information as the texture information file into the anti-fake inspection system database. Other steps are the same as above.

### Embodiment 11

As shown in FIG. 22, 80 g/m² white coated paper sticker material is used to print the printed matter. Firstly, a unique two-dimensional code (i.e., code) is printed on the front surface. Then, bunches of film yarn (fiber yarn for short)-fancy yarn including random fibers are pulled out from the spinning reel, and put beside the two-dimensional code of the coated paper according to the spacing of the printed matters. Then, a laminating unit is used to coat the matte transparent BOPP prepared in advance to serve as the surface layer of the medicine box. Finally, the surface layer is die-cut and discarded, so as to manufacture pieces of printed matters sandwiched with fiber yarn (also known as safety yarn). Other steps can be the same as those of embodiment 1.

### Embodiment 12

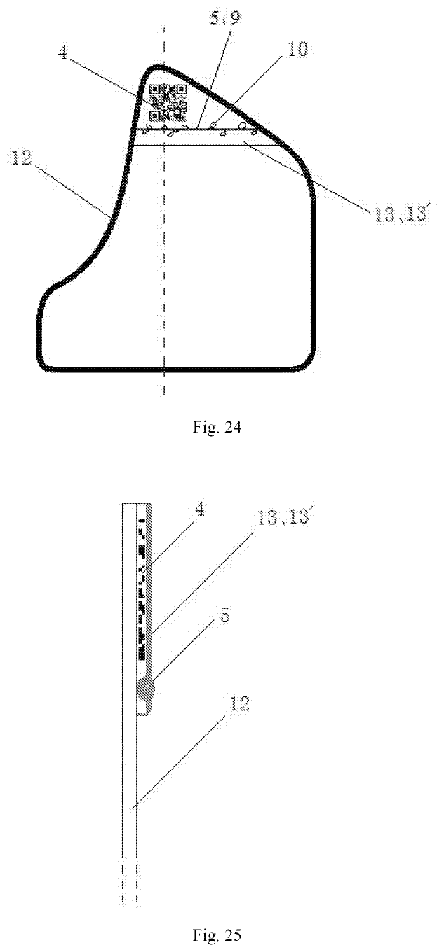

As shown in FIG. 24 and FIG. 25, 80 g/m² white coated paper sticker material is used to print a lubricating oil bottle label of a certain brand-product package. Firstly, a unique two-dimensional code (i.e., code) is printed on the front surface. Then, the fancy yarn with hot melting at 85° C. (low melting point) is pulled out of the spinning reel, put in a position 2-8 mm away from the two-dimensional code on the front surface of the sticker coated paper according to the layout spacing of the bottle labels, and hot-pressed, softened and pasted on the coated paper by a hot roller at 83° C. Then, partial transparent varnish layers are printed on the two-dimensional code and the fancy yarn to serve as partial surface layers of the bottle labels. Finally, the surface layers are die-cut and discarded, so as to manufacture pieces of product packages of the flat texture string stuck with a segment of fancy yarn and the personalized elements on the front surface. Other steps can be the same as those of embodiment 1.

### Embodiment 13

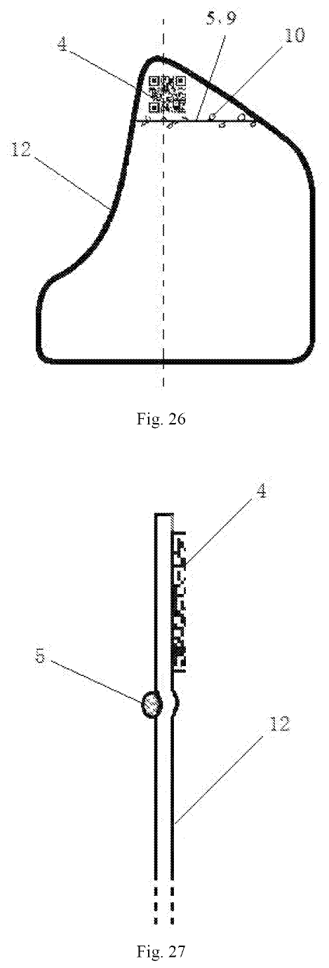

As shown in FIG. 26 and FIG. 27, 30 μm thick transparent PE sticker material is used to print a lubricating oil bottle label of a certain brand-product package. Firstly, a unique two-dimensional code (i.e., code) is printed on the front surface. Then, the fancy yarn is pulled out of the spinning reel, put and stuck in a position near the two-dimensional code on the back surface of the transparent PE sticker material according to the layout spacing of the bottle labels, and rolled and smoothed by a press roller. Finally, the fancy yarn is die-cut and discarded, so as to manufacture pieces of product packages of the flat texture string stuck with the fancy yarn and the personalized elements on the back surface. Other steps can be the same as those of embodiment 1.

### Embodiment 14

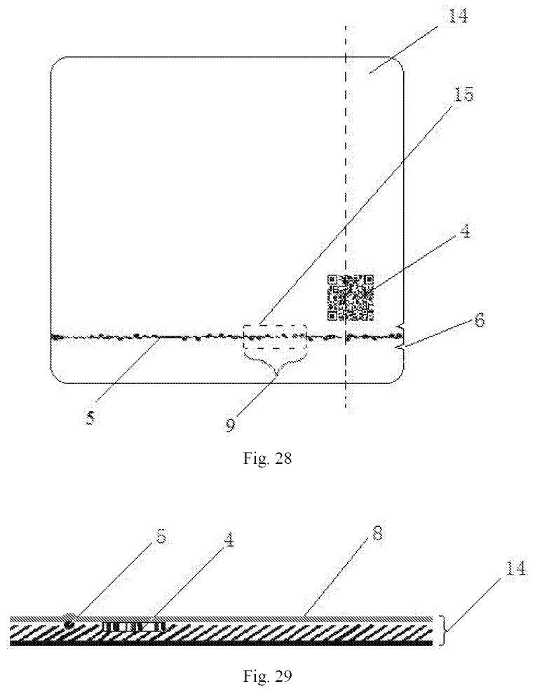

As shown in FIG. 28 and FIG. 29, a 22-μm thick BOPET as a transparent base layer is used to print a three-layer mask bag-composite package. Firstly, a unique two-dimensional code (i.e., code) is printed on the back surface. On the laminating machine, the fancy yarn is pulled out of the spinning reel, put in a position near the two-dimensional code between the BOPET bas layer and a VMPET barrier layer according to the layout spacing of the mask bags, attached with LDPE heat seal layers, and rolled and smoothed by a press roller to ensure that all the pimples thereon are flattened, clamped and fixed, thereby manufacturing a fancy yarn composite material embedded with pimple yarn. Finally, the fancy yarn composite material is cut and bagged, to manufacture a three-layer mask bag of the flat texture string-composite package sandwiched with a segment of pimple fancy yarn. In order to facilitate the public to observe and verify the authenticity, it is best to print a viewing area on the composite package to circle a flat texture string from the fancy yarn, only collect the feature information of the flat texture string in the viewing area and store the information as the texture information file into the anti-fake inspection system database (computer connected to the Internet). Other steps are the same as above. The transparent base layer in the present embodiment can also serve as the surface layer of the mask bag.

### Embodiment 15

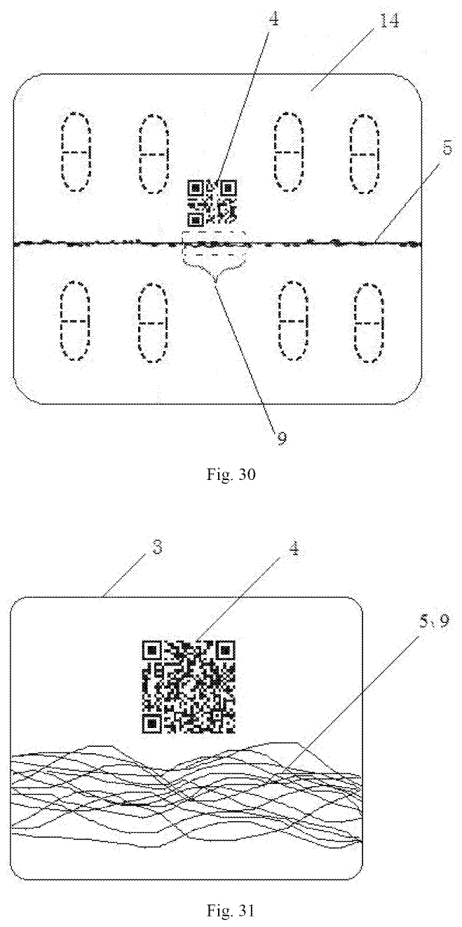

As shown in FIG. 30, a fancy yarn is embedded between a transparent plastic blister layer and a bottom plate layer of a board of medicine to manufacture boards of aluminum foil packaging medicine. Other steps can be the same as those of embodiment 1.

### Embodiment 16

As shown in FIG. 31, randomly bent fancy yarn are embedded into the printed matter. Other steps can be the same as those of embodiment 1.

### Embodiment 17

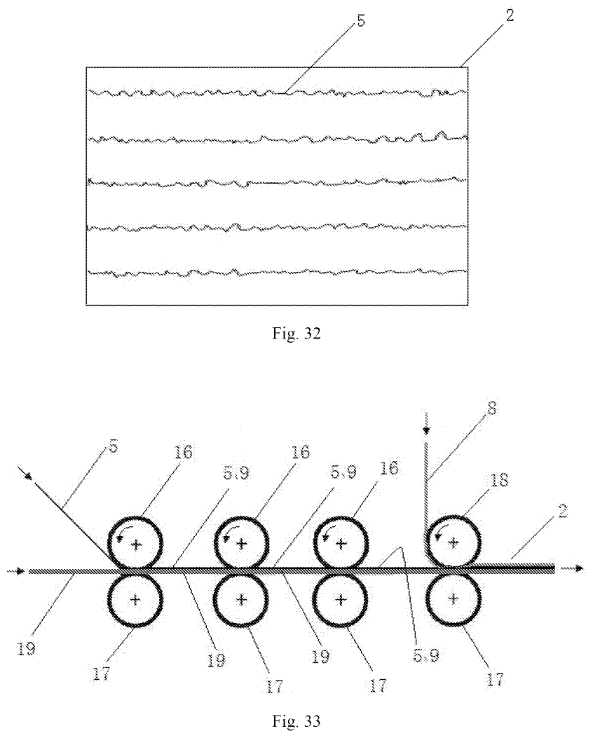

As shown in FIG. 32, in order to facilitate the use of typesetting, a common printed matter can also be manufactured to be shared by all users. For example, the monofilament textured fancy yarn in the printed matter is relatively evenly covered on the entire material, and the monofilament textured fancy yarn is flattened to 10-15 μm. In this way, regardless of the size of the printed matter, the printed matter can be, typeset randomly, and has fancy yarn. At least 1-2 strands of fancy yarn exist in the printed matter with small area. 3-5 or more strands of fancy yarn may exist in the printed matter with large area. Studies show that feature information such as multiple textured fancy yarn and their relative positions in the same printed matter is collected as texture information file, so as to greatly increase the difficulty of faking by manual reproduction.

### Embodiment 18

As shown in FIG. 33, in order to crush the fancy yarn and the personalized elements thereon to be very thin to manufacture an ultra-thin flat texture string to avoid affecting the post-processing procedure due to the convexity (thickening) of the region of the flat texture string on the printing material, a multi-roller super rolling technology can be used.

Firstly, 80 g/m² white coated paper is selected as the bottom layer, and loop yarn with a melting point lower than 85° C. are applied to the coated paper in parallel according to a preset spacing. The loop yarn is preferably selected from three plies (red, green and blue plies) of loop yarn of 530 Denier. The loop diameter is preferably 1 mm and the loop density is preferably 7 pieces/cm.

Then, the coated paper and the loop yarn applied thereon are successively super-rolled through three hot rollers with temperatures of 80° C., 85° C. and 90° C.; and the loop yarn and the personalized elements (such as pimples/loops) on the loop yarn are softened (or even melted) and stuck to the coated paper. Tests show that the flat texture string formed by such multi-stage hot pressing can be as thin as about 12 μm, but the pimples/loops and other personalized elements look very large and eye-catching, which meets the requirements of visual recognition of texture anti-fake technology.

Finally, in order to fix and protect the flat texture string and prevent manual moving (tampering) of the personalized elements, transparent surface layers must be coated on the coated paper and the flat texture string to completely shape the flat texture string. In this way, a hand-tear texture anti-fake material can be manufactured.

### Embodiment 19

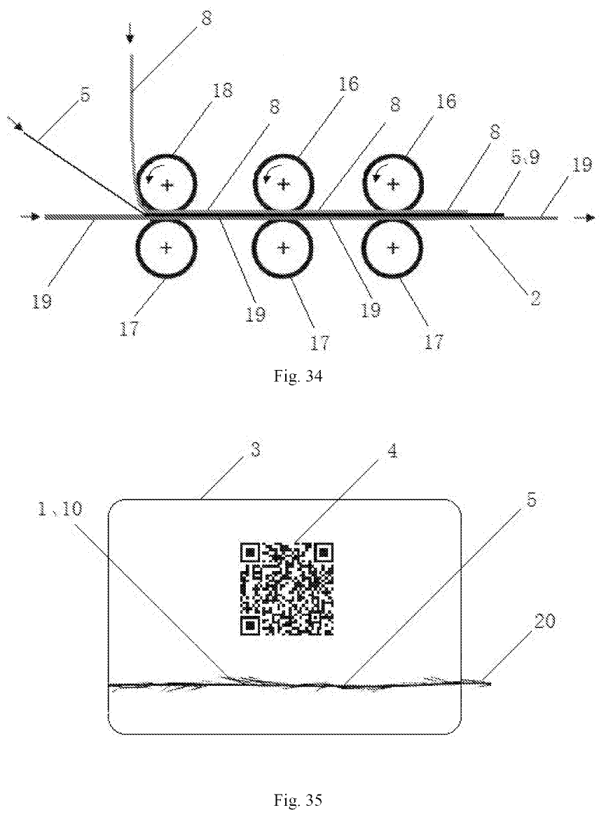

As shown in FIG. 34, in order to crush the fancy yarn and the personalized elements thereon to be very thin to manufacture an ultra-thin flat texture string to avoid affecting the post-processing procedure due to the convexity (thickening) of the region of the flat texture string on the printing material, a multi-roller super rolling technology can be used.

Firstly, 80 g/m² white coated paper is selected as the bottom layer, and loop yarn with a melting point lower than 85° C. are applied to the coated paper in parallel according to a preset spacing. The loop yarn is preferably selected from three plies (red, green and blue plies) of loop yarn of 150 Denier. The loop diameter is preferably 1.5 mm and the loop density is preferably 5 pieces/cm.

Then, a layer of 12 g/m² transparent copy paper is compounded as a surface layer through a composite roller. The coated paper, the printed matter compounded by the transparent copy paper, and the loop yarn applied therein is successively super-rolled through three hot rollers with temperatures of 85° C., 90° C. and 95° C., so as to soften (or even melt) and stick the loop yarn and the personalized elements (such as pimples/loops) into the printed matter to manufacture the hand-tear texture anti-fake material. Tests show that the local convexity (i.e., thickening) caused by the flat texture string formed by such multi-stage hot pressing is about 28 μm.

The above two embodiments illustrate a solution of flattening the fancy yarn and the personalized elements thereon and then conducting compounding shaping and protection, and also illustrate a solution of compounding the fancy yarn and the personalized elements thereon and then conducting flattening shaping and protection. The two solutions have respective advantages and disadvantages. The hand-tear texture anti-fake material produced in embodiment 18 has a very thin flat texture string, slight thickening, flat surface, is suitable for processing and production in various links after printing, and is suitable for being sold as raw material of anti-fake paper to other anti-fake enterprises. The hand-tear texture anti-fake material produced in embodiment 19 is seriously thickened, but is still within an allowable thickness range, is difficult to process and produce in each link after printing, but is a desirable technology for users who require a flat texture string with a strong hand feel (touchable by hand). It is best to set the thickness of the region of the flat texture string to be 50-68 μm more than the surrounding region.

The reason why the present invention has a requirement of coating the transparent surface layers (instead of exposing the flat texture string on the coated paper) to completely shape the flat texture string is because: (1) to prevent the flat texture string from being warped/deformed by accidental friction, (2) to prevent fakers from manually moving (tampering) the personalized features of the flat texture string and (3) to prevent the fakers from faking with manually stucking and imitated flat texture strings. Studies show that the flat texture string can only be used as a reliable personalized anti-fake feature after the flat texture string coated with the transparent surface layer (preferably a translucent surface layer) is completely shaped. In other words, if the fakers tamper the flat texture string, the transparent surface layer is inevitably destroyed, obvious traces are inevitably left on the printed matter, and consumers inevitably find the traces to complain.

### Embodiment 20

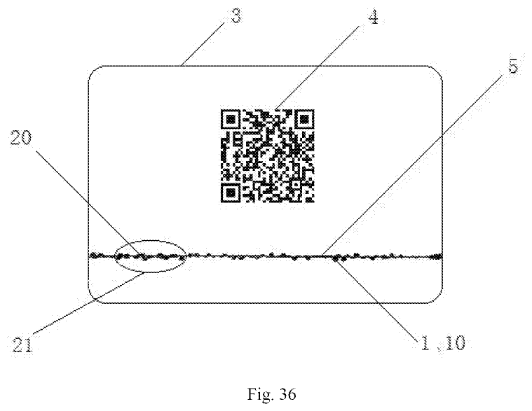

As shown in FIG. 35 and FIG. 36, a production technology similar to window safety thread paper or a partial transfer and covering technology is used to pull the fancy yarn from the spinning reel and intermittently embedded in the paper, so as to manufacture the printing material of the fancy yarn with brushed yarn-window fancy yarn paper. It is best not to squash the exposed line segment at the window to maintain a strong touch hand feeling.

The printed matter is printed using the above window fancy yarn paper, and a unique sequence code (i.e., code) including a link address is printed for each printed matter by using a coding machine.

An industrial-grade digital camera is prepared. After the stress of a flat texture string is released and the shape is completely set, each code and a nearby flat texture string in each printed matter which is composed of the fancy yarn and the feathers or loops and other personalized elements are shot to obtain file photos; then, the shot file photos about a segment of flat texture string in each printed matter and the corresponding code information (i.e., index code information) are stored in an anti-fake inspection system database as a basis for authenticity verification-texture information file.

If the public wants to identify the authenticity, a camera phone with a lens resolution of ≥5 million pixels can be used to take a photo of the code and the flat texture string nearby-the information to be inspected. The information to be inspected and the code information are uploaded together (including sending via SMS or WeChat) to the anti-fake inspection system database, and the anti-fake inspection system matches (identifies) the texture information of the flat texture string on the information to be inspected with the texture information file in the database. If matched, the information that the authentication conclusion is true is fed back to the camera phone; if not matched, the information that the authentication conclusion is false is fed back to the camera phone. Of course, the WeChat scanning software in the camera phone can also be used to scan the QR code (i.e., the code) to start the link, browse and view the photo file in the database, and check whether the features of the flat texture string are consistent with the photo file, so as to identify the authenticity.)

If the code is a copied fake logo, it is impossible to move the exposed line segment with fingers like the real solid line because the fake flat texture string is ink. Thus, both the user and the anti-fake inspection system should announce to the public:—If the flat texture string is not consistent with the texture information file, the printed matter inspected is false;—If the flat texture string is consistent with the texture information file, and the flat texture string of the printed matter inspected is a movable object, instead of unmovable printing ink, the printed matter inspected is true, otherwise is false.

After the public sees the announcement (also known as a warning), most people take actions: move the exposed line segment with hands, check whether a flat texture string exists in the printed matter, and finally determine the authenticity.

The above only discloses the preferred embodiments of the present invention, and of course, shall not be used to limit the scope of claims of the present invention. Therefore, equivalent changes made according to the claims of the present invention still belong to the scope of the present invention.

1. A hand-tearing texture anti-fake method, comprising that at least one unique code (4) for each printed matter (3) is compiled and printed, and the feature information of a random structural texture (1) on each printed matter (3) is collected and stored in correspondence to the code (4) in an anti-fake check system database as a texture information file of the printed matter (3) for the public to check the authenticity; and characterized by comprising the following steps:
\textcircled{1} embedding fancy yarn (5) under a transparent surface layer (8) on the printed matter (3); flattening and shaping the fancy yarn (5) and personalized elements (10) thereon, and thereby forming a line string of the random structural texture (1) with a flat and stable shape throughout the whole printed matter (3)—a flat texture string (9); and making the thickness of the area where the flat texture string (9) is located on the printed matter (3) greater than the surrounding area by 0-80 μm, 20-75 μm, 30-73 μm, 40-70 μm or 50-68 μm;
\textcircled{2} collecting the feature information of the flat texture string (9) in each printed matter (3), and storing the collected feature information in an anti-fake check system database as a texture information file;
\textcircled{3} the public uses smart phones to check by an anti-fake check system whether the features of the flat texture string (9) in the printed matter (3) are consistent with the texture information file thereof;
\textcircled{4} making a public announcement that
if the flat texture string (9) is a real object that can be torn out and/or toggled, the printed matter (3) checked is true; otherwise, the printed matter (3) checked is false.

2. The hand-tearing texture anti-fake method according to claim 1, characterized by comprising at least one of the following:
\textcircled{1} a hand-tearing line/opening (6) is formed by die cutting beside the flat texture string (9) on the printed matter (3);
\textcircled{2} at least one hand-tearing handle (7) or one exposed line segment (20) which can be toggled is arranged in the area where the flat texture string (9) is located on the printed matter (3):
\textcircled{3} the back of the hand-tearing handle (7) is provided with an adhesive-free layer;
\textcircled{4} the fancy yarn (5) is swung continually left and right during the embedding process to make the embedding position shifted left and right within a predetermined range of ≤10 mm, 5 mm, 2 mm, 1 mm, 0.5 mm or 0.3 mm;
\textcircled{5} the printed matter (3) is a product package (12);
\textcircled{6} First, the fancy yarn (5) in the printed matter (3) is rolled to make the yarn randomly deform into a flat texture string (9) with a flat shape and a thickness of 10-80 μm, 15-60 μm, 20-45 μm, 25-35 μm or 40-70 μm; and then the feature information of the flat texture string (9) is collected as a texture information file;
\textcircled{7} the fancy yarn (5) is heated and flattened at the temperature close to the softening point thereof;
\textcircled{8} the fancy yarn (5) is applied with static electricity by an electrostatic generator or blown during the embedding process to make the included angle φ (11) between the length direction of the fancy yarn (5) and the personalized elements (10) thereof increase under the action of electrostatic repulsive force/wind force;
\textcircled{9} the included angle φ (11) between the length direction of the fancy yarn (5) and a plurality of personalized elements (10) is greater than or equal to 15° or 30° and less than 90°;
\textcircled{10} the flat texture string (9) is pasted on the back of the transparent self-adhesive printed matter (3), pasted on the front of the printed matter (3) and covered and protected by a printed transparent varnish layer, pasted on the front of the printed matter (3) and covered and protected by a transparent transfer printing layer (13′), or embedded in the sandwich layer of a composite package (14);
\textcircled{11} the surface layer (8) of the printed matter (3) is provided with a transparent extinction layer;
\textcircled{12} The fancy yarn (5) is wrapped yarn, core-spun yarn, slub yarn, big-belly yarn, speck yarn, onde yarn, pigtail yarn, towel yarn, loop yarn, knot yarn, feather yarn, toothbrush yarn, pine yarn, oblique yarn, neckline yarn, track yarn, spiral yarn, centipede yarn, tape yarn, fiber yarn, chain yarn, metallic yarn, wired yarn, heather yarn, chine yarn, rainbow yarn, folded yarn, textured yarn or combination yarn;
\textcircled{13} the feature information of one or a plurality of segments with a length of L of the flat texture string (9) on the printed matter (3) is collected as a texture information file, wherein L is 3-30 mm, 3-90 mm or 3-300 mm;
\textcircled{14} the feature information of the flat texture string (9) in a viewing area (15) on the printed matter (3) is collected as a texture information file;
\textcircled{15} the printing material (2) required for the printed matter (3) and embedded with the hot melt fancy yarn (5) tis heated to the temperature close to the melting point of the hot melt fancy yarn (5) and super-rolled to make the hot melt fancy yarn (5) randomly deform into the flat texture string (9) with a flat shape and a thickness of 10-45 μm or 25-35 μm, and after the shape of the flat texture string (9) is stable, the feature information of the flat texture string (9) with a flat shape is collected as a texture information file;
\textcircled{16} the information made public comprises that: a product of which the personalized elements (10) remain on the printed matter (3) after the main stem of the fancy yarn (5) is torn out is false.

3. A hand-tearing texture anti-fake product, comprising a printed matter (3) and a random structural texture (1) thereof, wherein a unique code (4) is printed on the printed matter (3), and the feature information of the random structural texture (1) is collected and stored in correspondence to the code (4) in an anti-fake check system database as an anti-fake feature information file of the printed matter (3); and characterized in that: fancy yarn (5) is embedded under a transparent surface layer (8) on the printed matter (3); the fancy yarn (5) and personalized elements (10) thereon are flattened and shaped, thereby forming a line string of the random structural texture (1) with a flat and stable shape throughout the whole printed matter (3)—a flat texture string (9); the thickness of the area where the flat texture string (9) is located on the printed matter (3) is greater than the surrounding area by 0-80 μm, 20-75 μm, 30-73 μm, 40-70 μm or 50-68 μm; and the feature information of the flat texture string (9) is collected as an anti-fake feature information file of the printed matter (3).

4. The hand-tearing texture anti-fake product according to claim 3, characterized by comprising at least one of the following:
\textcircled{1} a hand-tearing line/opening (6) is formed by die cutting beside the flat texture string (9) on the printed matter (3);
\textcircled{2} at least one hand-tearing handle (7) or one exposed line segment (20) which can be toggled is arranged in the area where the flat texture string (9) is located on the printed matter (3);
\textcircled{3} the back of the hand-tearing handle (7) is provided with an adhesive-free layer;
\textcircled{4} the flat texture string (9) is embedded within a predetermined range of ≤10 mm, 5 mm, 2 mm, 1 mm, 0.5 mm or 0.3 mm;
the printed matter (3) is a product package (12);
\textcircled{5} the flat texture string (9) is flattened to a thickness of 10-80 μm, 15-60 μm, 20-45 μm, 25-35 μm or 40-70 μm; and the width M of the flat texture string (9) is greater than or equal to 200 μm, 500 μm or 1200 μm;
\textcircled{7} the included angle φ (11) between the length direction of the fancy yarn (5) and a plurality of personalized elements (10) thereon is greater than or equal to 15° or 30° and less than 90°;
\textcircled{8} the flat texture string (9) is pasted on the back of the transparent self-adhesive printed matter (3), pasted on the front of the printed matter (3) and covered and protected by a printed transparent varnish layer (13), pasted on the front of the printed matter (3) and covered and protected by a transparent transfer printing layer (13′), or embedded in the sandwich layer of a composite package (14);
\textcircled{9} when the shape of the personalized elements (10) is a circle or point, the diameter of the circle or point is 0.1-3 mm, 0.2-2 mm or 1-2 mm; or when the shape of the personalized elements (10) is a line the width of the line is greater than or equal to 0.03 mm, 0.05 mm, 0.07 mm or 0.10 mm, and the length of the line is 0.3-0.7 mm, 0.3-1.2 mm, 0.3-1.8 rum, 0.3-3 mm or 0.3-5 mm;
the fancy yarn (5) is loop yarn with a loop diameter of 0.1-3 mm, 0.2-2 mm or 1-2 mm, and a loop density of 2-20 loops/cm;
\textcircled{10} the fancy yarn (5) is wrapped yarn, core-spun yarn, slub yarn, big-belly yarn, speck yarn, onde yarn, pigtail yarn, towel yarn, loop yarn, knot yarn, feather yarn, toothbrush yarn, pine yarn, oblique yarn, neckline yarn, track yarn, spiral yarn, centipede yarn, tape yarn, fiber yarn, chain yarn, metallic yarn, wired yarn, heather yarn, chine yarn, rainbow yarn, folded yarn, textured yarn or combination yarn;
\textcircled{12} the flat texture string (9) and the surface layer (8) are not bonded by adhesive; or the flat texture string (9) and a bottom layer (19) are not bonded by adhesive.

5. The hand-tearing texture anti-fake product according to claim 4, characterized in that: the loop yarn is three-strand yarn, wherein at least two strands of yarn have different colors; single yarn constituting the same strand of yarn is formed by twisting at least two fiber bundles with different colors in the loop yarn; or, the exposed line segment (20) which can be toggled is not flattened on the printed matter (3).

6. A hand-tearing texture anti-fake material, comprising a printing material (2) and a random structural texture (1) thereof, and characterized in that: fancy yarn (5) is embedded under a transparent surface layer (8) on the printing material (2); the fancy yarn (5) and personalized elements (10) thereon are flattened and shaped, thereby forming a line string of the random structural texture (1) with a flat and stable shape throughout the whole printing material (2)—a flat texture string (9); and the thickness of the area where the flat texture string (9) is located on the printing material (2) is greater than the surrounding area by 0-80 μm, 20-75 μm, 30-73 μm, 40-70 μm or 50-68 μm.

7. The hand-tearing texture anti-fake material according to claim 6, characterized by comprising at least one of the following:
\textcircled{1} the flat texture string (9) is embedded within a predetermined range of ≤10 mm, 5 mm, 2 mm, 1 mm, 0.5 mm or 0.3 mm;
\textcircled{2} the fancy yarn (5) and personalized elements (10) thereon are flattened and shaped into a flat texture string (9) with a thickness of 10-80 μm, 15-60 μm, 20-45 μm, 25-35 μm or 40-70 μm; and the width M of the flat texture string (9) is greater than or equal to 200 μm, 500 μm, 1200 μm or the thickness of the printing material (2);
\textcircled{3} the included angle φ (11) between the length direction of the fancy yarn (5) and a plurality of personalized elements (10) thereon is greater than or equal to 15° or 30° and less than 90°;
\textcircled{4} the flat texture string (9) is embedded in the sandwich layer of the composite material;
\textcircled{5} fancy yarn (5) randomly bending is embedded in the printing material (2);
\textcircled{6} when the shape of the personalized elements (10) is a circle or point, the diameter of the circle or point is 0.1-3 mm, 0.2-2 mm or 1-2 mm; or when the shape of the personalized elements (10) is a line, the width of the line is greater than or equal to 0.03 mm, 0.05 mm, 0.07 mm or 0.10 mm, and the length of the line is 0.3-0.7 mm, 0.3-1.2 mm, 0.3-1.8 mm, 0.3-3 mm or 0.3-5 mm;
\textcircled{7} the fancy yarn (5) is loop yarn with a loop diameter of 0.1-3 mm, 0.2-2 mm or 1-2 mm, and a loop density of 2-20 loops/cm;
\textcircled{8} the fancy yarn (5) is hot melt yarn with the melting point lower than 85° C. or 110° C.;
\textcircled{9} the fancy yarn (5) is wrapped yarn, core-spun yarn, slub yarn, big-belly yarn, speck yarn, onde yarn, pigtail yarn, towel yarn, loop yarn, knot yarn, feather yarn, toothbrush yarn, pine yarn, oblique yarn, neckline yarn, track yarn, spiral yarn, centipede yarn, tape yarn, fiber yarn, chain yarn, metallic yarn, wired yarn, heather yarn, chine yarn, rainbow yarn, folded yarn, textured yarn or combination yarn;
\textcircled{10} the flat texture string (9) and the surface layer (8) are not bonded by adhesive; or the flat texture string (9) and a bottom layer (19) are not bonded by adhesive.

8. The hand-tearing texture anti-fake material according to claim 7, characterized in that: the loop yarn is three-strand, yarn, wherein at least two strands of yarn have different colors; or single yarn constituting the same strand of yarn is formed by twisting at least two fiber bundles with different colors in the loop yarn.

9. The hand-tearing texture anti-fake material according to claim 7, characterized in that: a plurality of exposed line segments (20) which can be toggled are arranged on the surface of the printing material (2); or a plurality of exposed line segments (20) which are not flattened and can be toggled are arranged on the surface of the printing material (2).
